(19) United States
(12) Patent Application Publication
(10) Pub. No.: US 2014/0251862 A1
(43) Pub. Date: Sep. 11, 2014

(54) PILL CONTAINERS WITH REGISTERS AND METHODS

(71) Applicant: APOTHECARY PRODUCTS, INC., Burnsville, MN (US)

(72) Inventors: Robert N. Priebe, Bloomington, MN (US); Terrance O. Noble, Burnsville, MN (US)

(73) Assignee: Apothecary Products, Inc., Burnsville, MN (US)

(21) Appl. No.: 13/789,977

(22) Filed: Mar. 8, 2013

(51) Int. Cl. A61J 1/03

(52) U.S. Cl. CPC A61J 1/03
USPC 206/534; 206/538

(57) ABSTRACT

A multiple compartment container includes a base having at least first and second rows of compartments and a plurality of lids. A cover is movably attached to the base and is adjacent to and spaced from a bottom wall of the base to define a register holder therebetween. A method of using a multiple compartment container includes moving the cover relative to the base to provide access to the register holder.

### TECHNICAL FIELD

This disclosure relates to multiple compartment pill containers. In particular, this disclosure relates to multiple compartment pill containers having a medication register and methods of use.

### BACKGROUND

For persons who need to take medicine regularly, the need for a pill container that can be easily carried is important. A pill container that is easy to use, has sufficient capacity for the person's needs, and which can be conveniently carried by the user increases the likelihood that the user will take the correct medication at the correct time.

Some pill containers are difficult for people with arthritis, poor dexterity, poor eyesight, or weak muscles. In addition, some people have more complex medication schedules, and they may not remember which medications need to be taken at what frequency.

Improvements in pill containers to address these shortcomings are desirable.

### SUMMARY

In one aspect, a multiple compartment container is provided including a base having at least first and second rows of compartments. Each compartment has an access opening providing access to an interior volume. The base has a base front wall, a base rear wall opposite of the base front wall, a first side wall extending between the base front wall and base rear wall, a second side wall extending between the base front wall and rear wall, and a base bottom wall opposite of the access opening. Each compartment row has a front row wall and a rear row wall. The container includes a plurality of lids. Each lid has an attached end that is movably attached to the rear row wall, and a free end movable to and away from the front row wall such that the lid selectively covers and uncovers the access opening of a respective compartment. A cover is movably attached to the base and is adjacent to and spaced from the bottom wall to define a register holder therebetween.

In another aspect, a method of using a multiple compartment container is provided. The method includes providing a container including a base having at least first and second rows of compartments, each compartment having an access opening providing access to an anterior volume. The base has a base front wall, a base rear wall opposite of the base front wall, a first side wall extending between the base front wall and base rear wall, a second side wall extending between the base front wall and rear wall, and a base bottom wall opposite of the access opening. Each compartment row has a front row wall and a rear row wall. The container includes a plurality of lids. Each lid has an attached end that is movably attached to the rear row wall and a free end movable to and away from the front row wall such that the lid selectively covers and uncovers the access opening of a respective compartment. A cover is movably attached to the base and is adjacent to and spaced from the bottom wall to define a register holder therebetween. The method includes moving the cover relative to the base to provide access to the register holder.

A variety of examples of desirable product features or methods are set forth in part in the description that follows, and in part will be apparent from the description, or may be learned by practicing various aspects of the disclosure. The aspects of the disclosure may relate to individual features as well as combinations of features. It is to be understood that both the foregoing general description and the following detailed description are explanatory only, and are not restrictive of the claimed invention.

### BRIEF DESCRIPTION OF THE DRAWINGS

FIG. 1 is a perspective view of a first embodiment of a multiple compartment container constructed in accordance with principles of this disclosure;

FIG. 2 is a top view of the container of FIG. 1;

FIG. 3 is a bottom view of the container of FIG. 1, without the register cover in place for purposes of enhancing visibility;

FIG. 4 is a bottom view of the container of FIG. 1 with the register cover in place;

FIG. 5 is a cross sectional view of the container of FIG. 1, the cross section being taken along the line 5-5 of FIG. 2;

FIG. 6 is an exploded perspective view of the container of FIG. 1;

FIG. 7 is a perspective view of the base used in the container of FIG. 1;

FIG. 8 is a top view of the base of FIG. 7;

FIG. 9 is a bottom view of the base of FIG. 7;

FIG. 10 is a cross sectional view of the base, the cross section being taken along the line 10-10 of FIG. 8;

FIG. 11 is another cross sectional view of the base of FIG. 7, the cross section being taken along the line 11-11 of FIG. 8;

FIG. 12 is a top view of lids that are used with the container of FIG. 1;

FIG. 13 is a left view of the lids of FIG. 12;

FIG. 14 is a right view of the lids of FIG. 12;

FIG. 15 is a perspective view of tab that is used in the container of FIG. 1;

FIG. 16 is a top view of the tab of FIG. 15;

FIG. 17 is a bottom view of the tab of FIG. 15;

FIG. 18 is a left view of the tab of FIG. 15;

FIG. 19 is a top view of a registration card that is usable with the container of FIG. 1;

FIG. 20 is a top view of the cover for the register holder used with the container of FIG. 1;

FIG. 21 is a perspective view of a second embodiment of a multiple compartment container constructed in accordance with principles of this disclosure;

FIG. 22 is a bottom perspective view of the container of FIG. 21;

FIG. 23 is a top view of the container of FIG. 21;

FIG. 24 is a right view of the container of FIG. 21;

FIG. 25 is a left view of the container of FIG. 21;

FIG. 26 is a front view of the container of FIG. 21;

FIG. 27 is a perspective view of flexible pill holders that are used with the register holder of FIG. 21;

FIG. 28 is an exploded, perspective view of the container of FIG. 21;

FIG. 29 is a bottom exploded perspective view of the container of FIG. 21;

FIG. 30 is a bottom view of the container of FIG. 21, the cover being omitted from the view to enhance visibility of the structure underneath the cover;

FIG. 31 is a cross sectional view of the container of FIG. 21, the cross section being taken along the line 31-31 of FIG. 23;

FIG. 32 is a cross sectional view of the container of FIG. 21, the cross section being taken along the line 32-32 of FIG. 30;

FIG. 33 is a perspective view of a base used for the container of FIG. 21;

FIG. 34 is a bottom view of the base of FIG. 33;

FIG. 35 is a top view of the base of FIG. 33;

FIG. 36 is a cross sectional view of the base of FIG. 33, the cross section being taken along the line 36-36 of FIG. 35;

FIG. 37 is a cross sectional view of the base of FIG. 33, the cross section being taken along the line 37-37 of FIG. 35;

FIG. 38 is a cross sectional view of the container, similar to the cross section of FIG. 31, but showing the lids in an open position;

FIG. 39 is a top view of lids used with the container of FIG. 21;

FIG. 40 is a right view of the lids of FIG. 39;

FIG. 41 is a cross sectional view of the lids of FIG. 39; the cross section being taken along the line 41-41 of FIG. 39;

FIG. 42 is a top view of a cover used with the container of FIG. 21;

FIG. 43 is a rear view of the container of FIG. 21;

FIG. 44 is a front view of the container of FIG. 1;

FIG. 45 is a rear view of the container of FIG. 1;

FIG. 46 is a perspective view of a third embodiment of a multiple compartment container constructed in accordance with principles of this disclosure;

FIG. 47 is a bottom view of the container of FIG. 46 showing the cover slid relative to the base to provide access to the register holder;

FIG. 48 is a bottom view of the container of FIG. 46, and showing the cover completely slid over the register holder;

FIG. 49 is an exploded perspective view of the container of FIG. 46;

FIG. 50 is a perspective view of the bottom of the base used in the container of FIG. 46;

FIG. 51 is a bottom view of the base used in the container of FIG. 46; and

FIG. 52 is a side view of the cover used with the container of FIG. 46.

### DETAILED DESCRIPTION

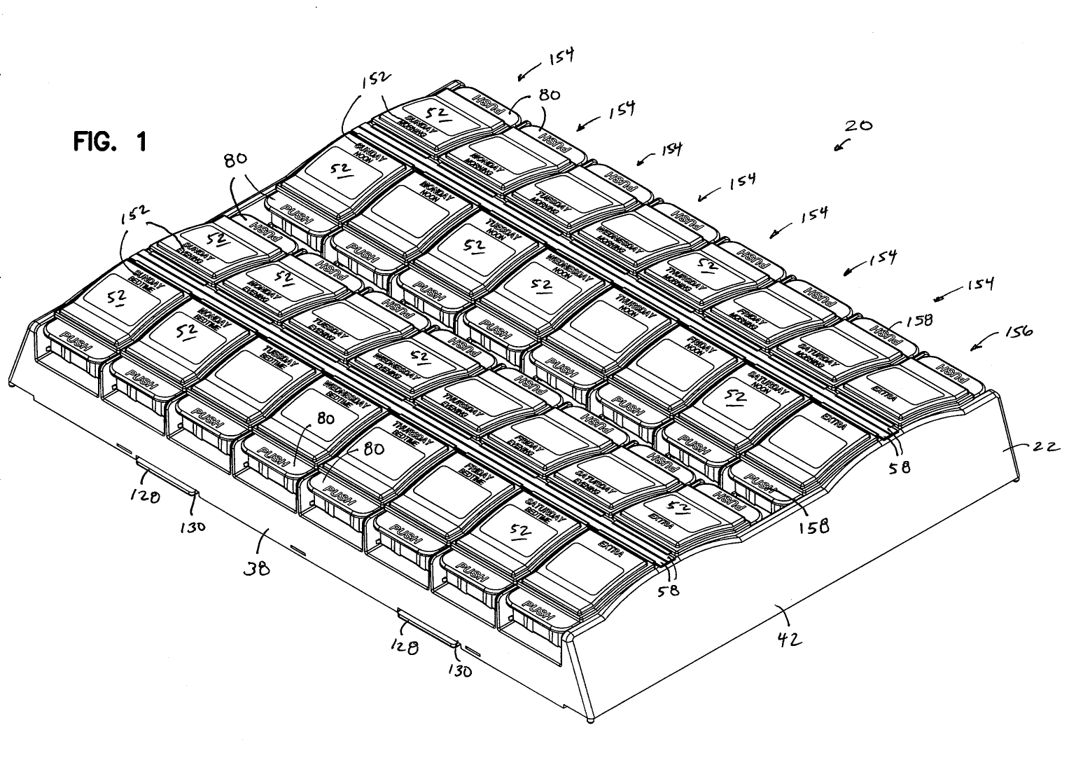

FIGS. 1, 21 and 46 depict three example embodiments of multiple compartment containers generally at reference numerals 20, 220, and 320. In general, containers 20, 220, and 320 are usable to hold or store items, such as pills. While pills will be the example discussed, it should be understood that pills can mean vitamins, or it can also mean non-medicinal items. The pills, or whatever items are used, are stored within the container 20, 220, and 320 and can be selectively accessed for later use.

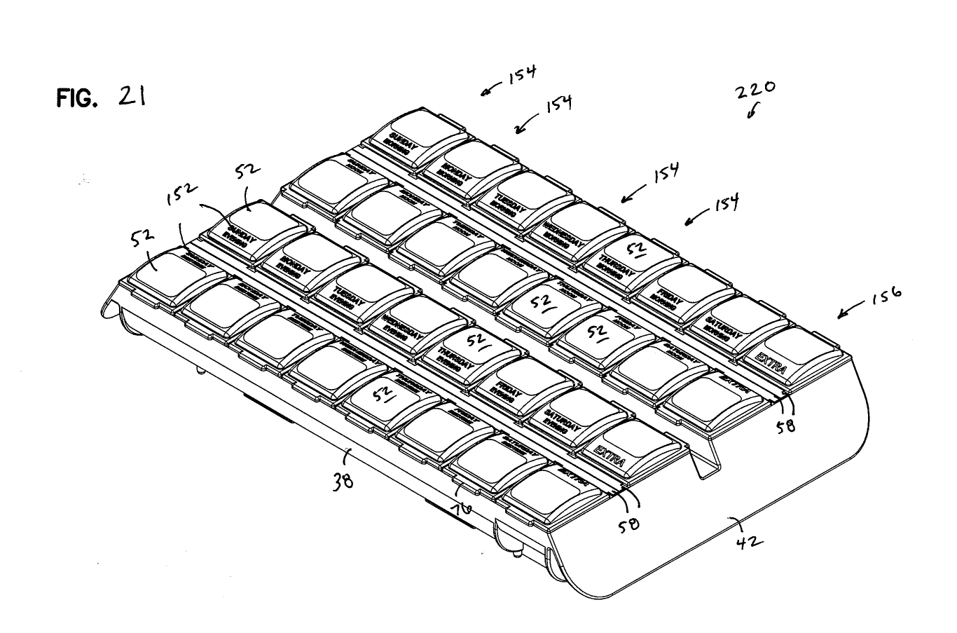

The containers 20, 220, and 320 have many features in common, and the same reference numerals will be used for both embodiments for analogous features. One main difference between the embodiments of container 20 and 220 includes the mechanism for opening the lids. The embodiment of FIG. 1 has push buttons to open the lids, while the embodiment of FIG. 21 has simple snap closures. One main difference between the embodiments of container 320 from the embodiments of containers 20 and 220 is how the cover is moveably attached to the base. The container 320 has a cover that is slideably attached to the base, while the containers 20, 220 have a cover that is pivotably attached to the base. These details are discussed further below.

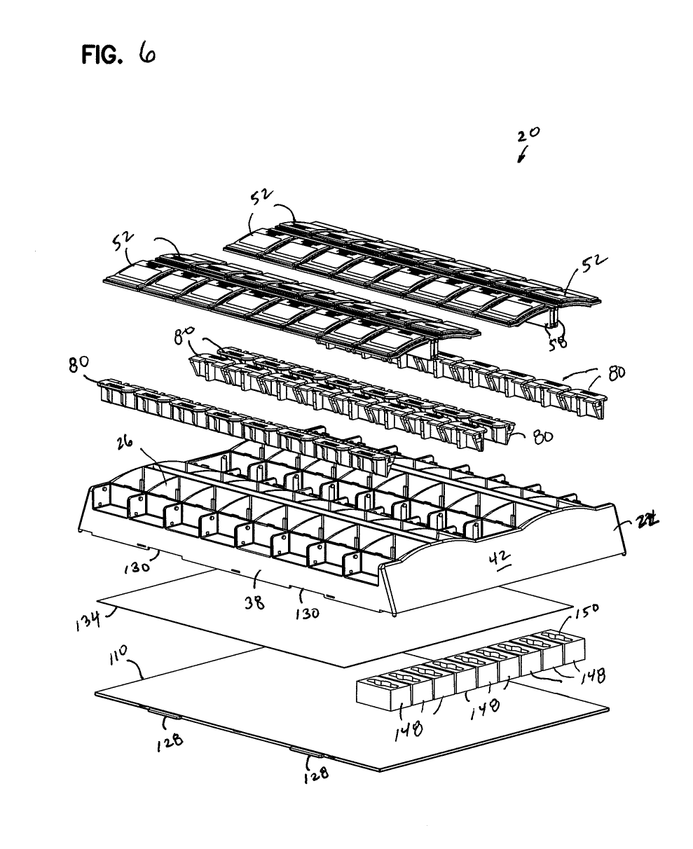

The pill container 20, 220, 320 includes a base 22 defining at least one compartment 24. In the illustrated embodiments, at least one compartment 24 includes a plurality of compartments 24. The compartments 24 are separated from each other by a plurality of dividers 26 (FIGS. 7 and 33).

The compartments 24 each have an access opening 28 providing access to a pill-holder interior volume 30.

In the example embodiments illustrated, the multiple compartment containers 20, 220, 320 has at least first and second rows 32, 33 of compartments 24. In the example shown, the base 22 includes, in addition to the first and second rows 32, 33 third and fourth rows 34, 35 of compartments 24. While different embodiments are possible, in the examples shown, each of the rows 32-35 includes eight compartments 24 in each row. In other embodiments, there can be fewer rows and more compartments in each row, while in other embodiments, there can be more than four rows and fewer compartments in each row. Still in other embodiments, there can be more rows than four and more compartments than eight in each row.

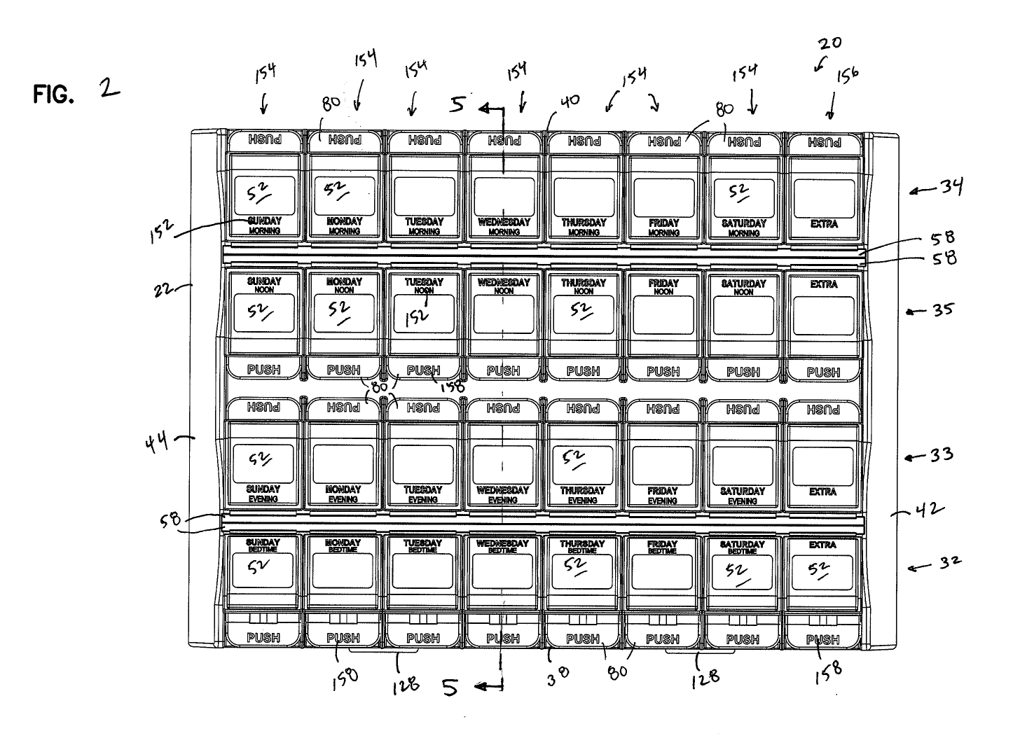

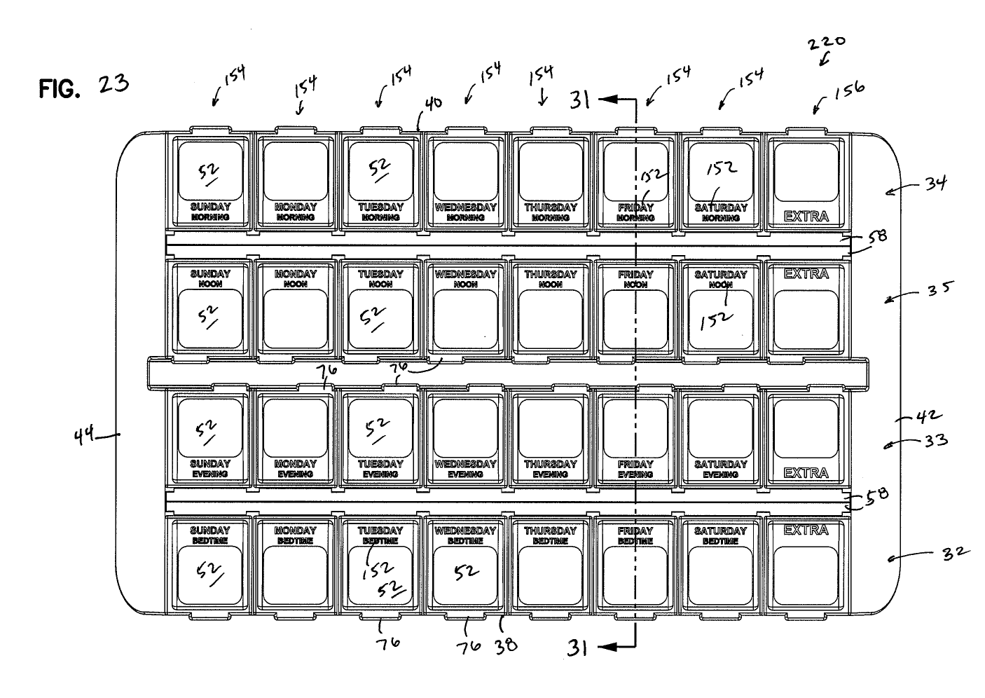

From a review of FIGS. 2 and 23, it should be appreciated that, in these examples shown, there are eight compartments 24 in each of the first, second, third, and fourth rows 32-35 to result in four rows having eight compartments 24 and eight columns having four compartments 24.

The base 22 includes a front wall 38, a base rear wall 40, a base first side wall 42 extending between the front wall 38 and rear wall 40, a base second side wall 44 extending between the front wall 38 and rear wall 40, and a base bottom wall 46 opposite of the access openings 28. The base bottom wall 46 also extends between the front wall 38 and rear wall 40 and between the first side wall 42 and second side wall 44.

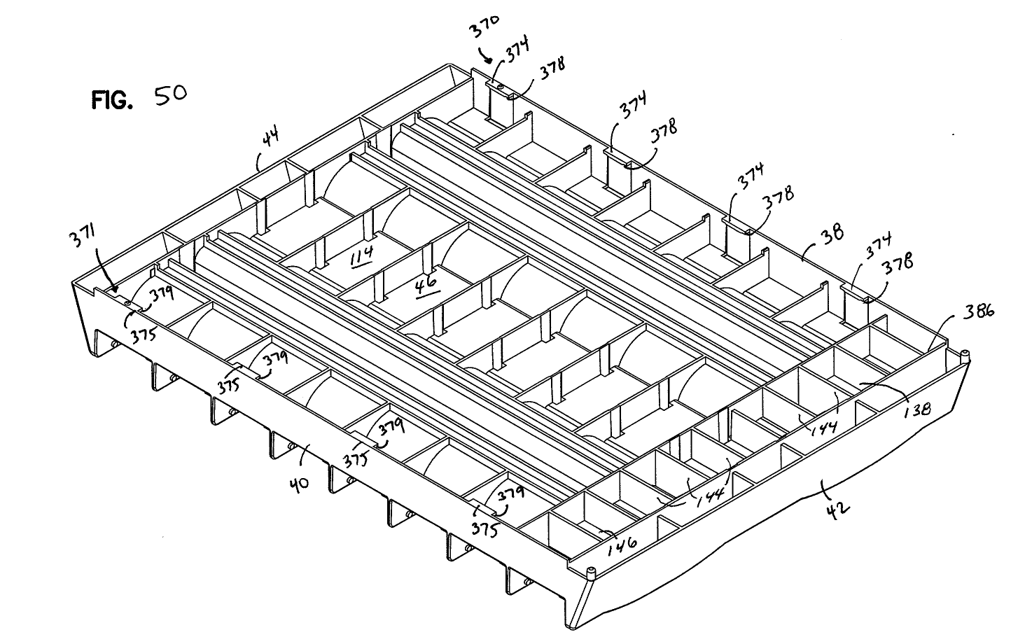

Each of the compartment rows 32-35 has a front row wall 48 and a rear row wall 50. As can be seen in FIGS. 7, 8, 33, 35, and 49 in these embodiments, the first and second rows 32, 33 are arranged so that the rear row walls 50 of these two adjacent rows are next to each other, while the front row walls 48 for rows 32, 33 are separated by the two rear row walls 50 in between. Similarly, the adjacent third and fourth rows 34, 35 are arranged so that their rear row walls 50 are next to each other, and their front row walls 48 are separated from each other by the two rear row walls 50 in between. In the example shown, the first row 32 and third row 34 are arranged to be along the base front wall 38 and base rear wall 40, respectively. The second row 33 and fourth row 35 are arranged to be in between the first row 32 and third row 34. In the example embodiment illustrated, the second row 33 and fourth row 35 are arranged relative to each other so that their front row walls 48 are adjacent to each other, without any rear row walls 50 in between.

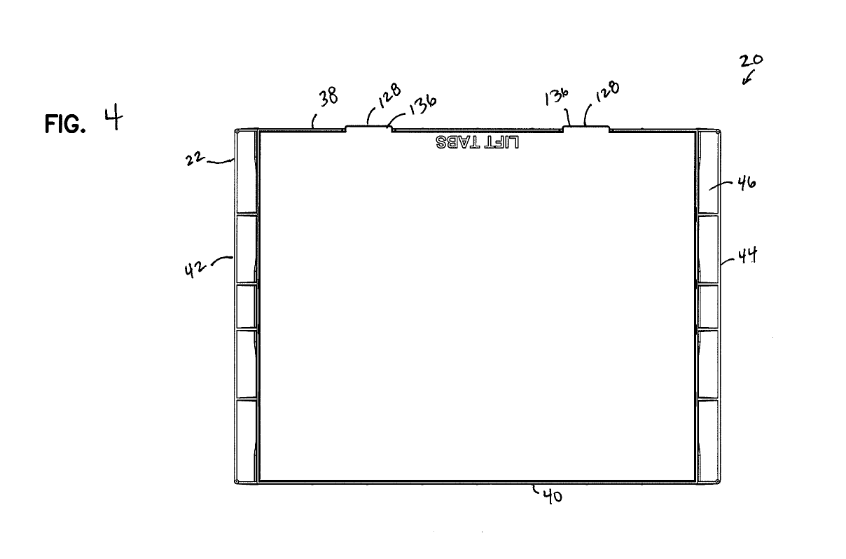

The container 20, 220, 320 includes a plurality of lids 52. Each lid 52 is movable between a covering position (FIGS. 1, 21, and 46) and an open position (FIGS. 5 and 38). The lids 52 for container 320 are the same as for container 20, so the open position for container 320 has the same appearance as in FIG. 5. The covering position is a position in which a respective one of the lids 52 covers the access opening 28 of a respective one of the compartments 24. In this way, access to the pill holder interior volume 30 is also blocked. The open position is a position in which a respective one of the lids 52 is spaced away from a respective one of the compartments 24 and away from the access opening 28 to allow access to the interior volume 30.

In the illustrated embodiments, each lid 52 includes an attached end 54 and an opposite free end 56. The attached end 54 is movably attached to the rear row wall 50. This movable attachment can be through a variety of means, such as by a living hinge. The free end 56 is movable to and away form the front row wall 48 such that the lid 52 selectively covers and uncovers the access opening 28 of a respective compartment 24.

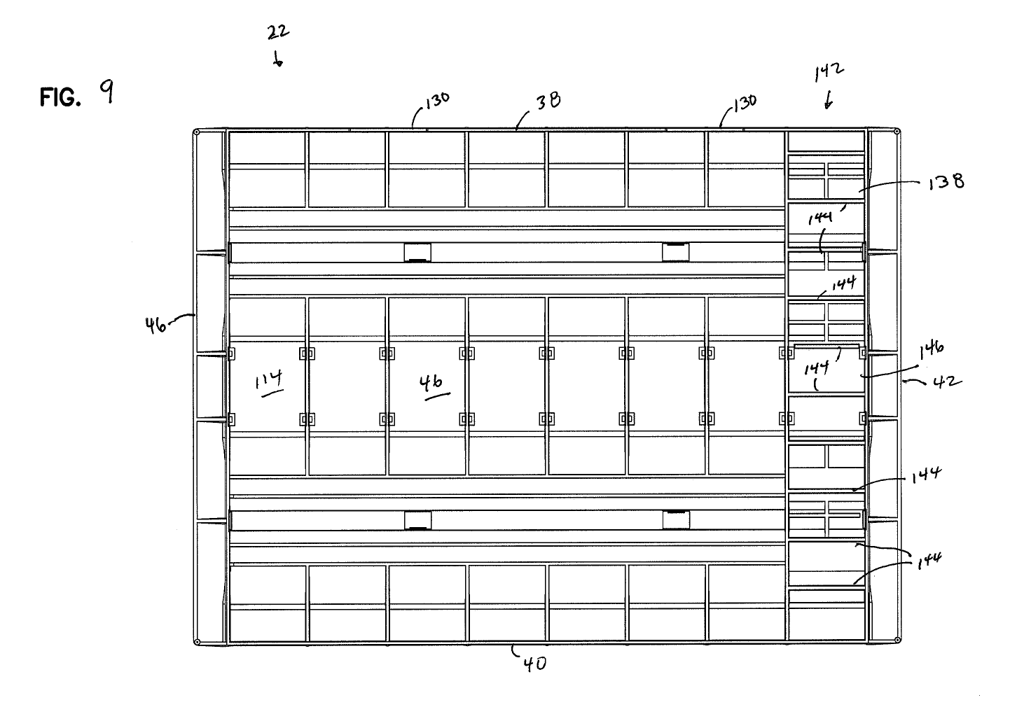

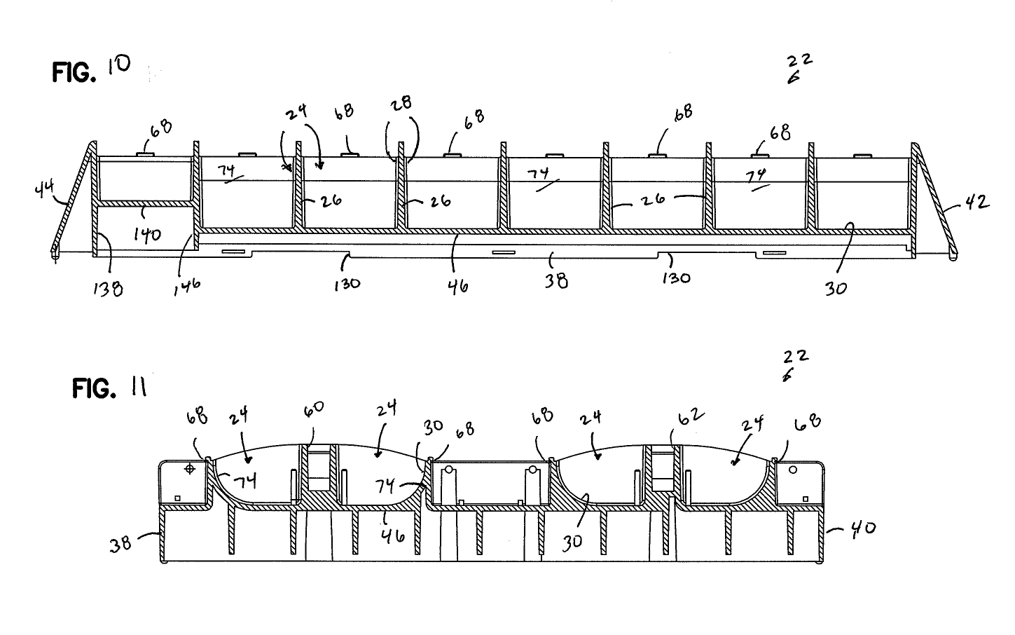

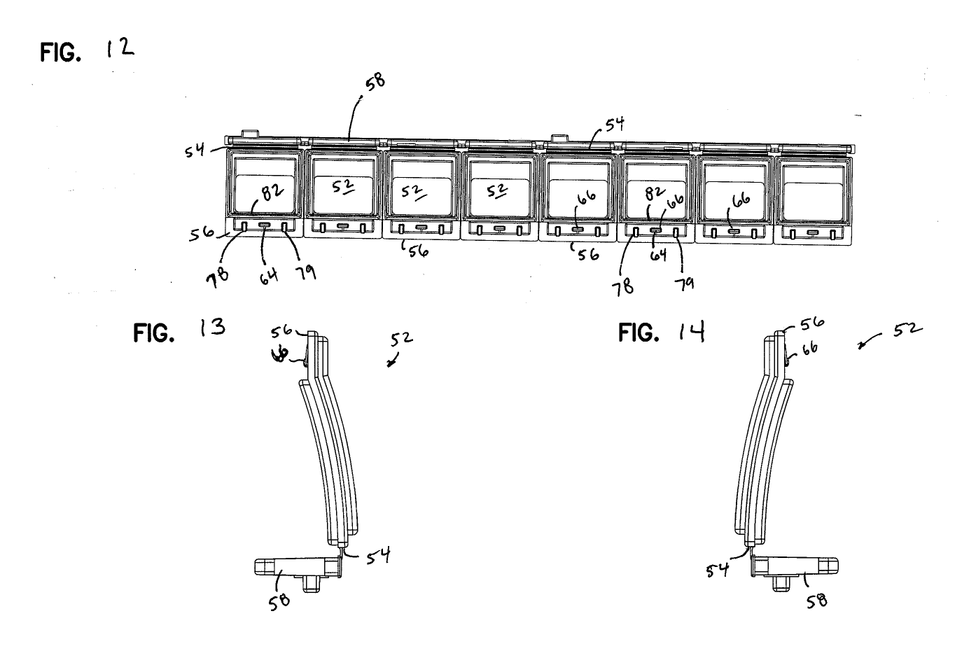

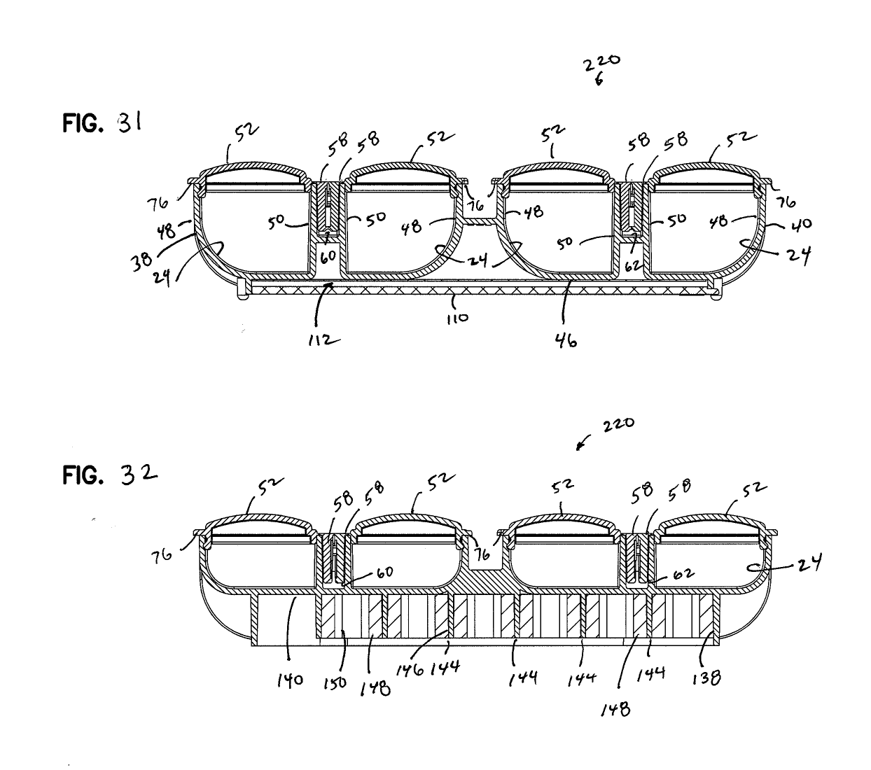

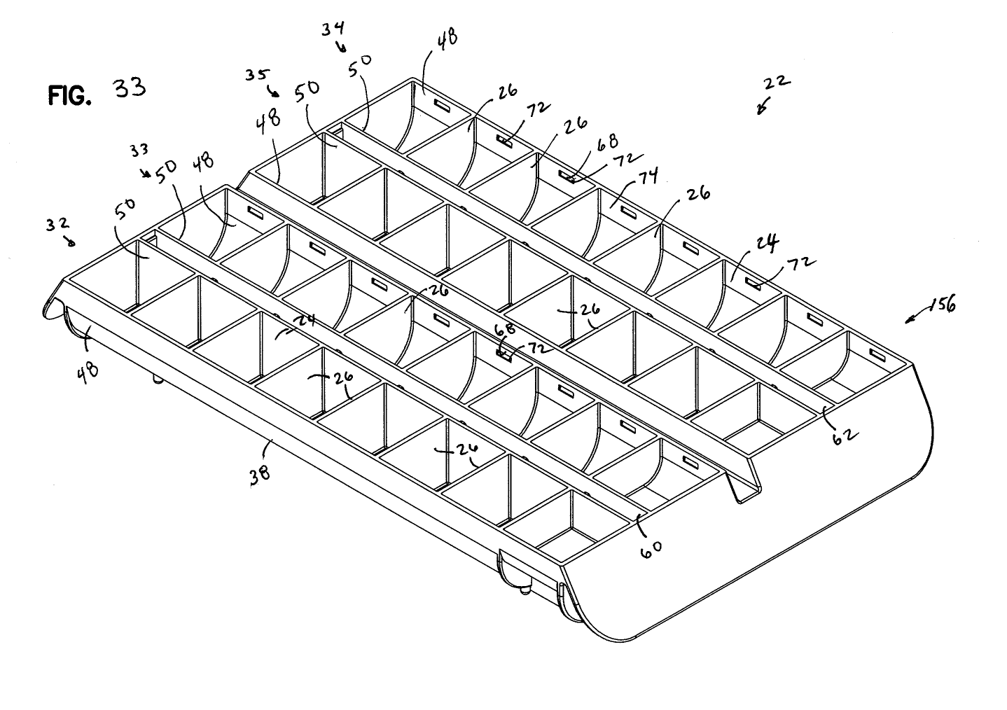

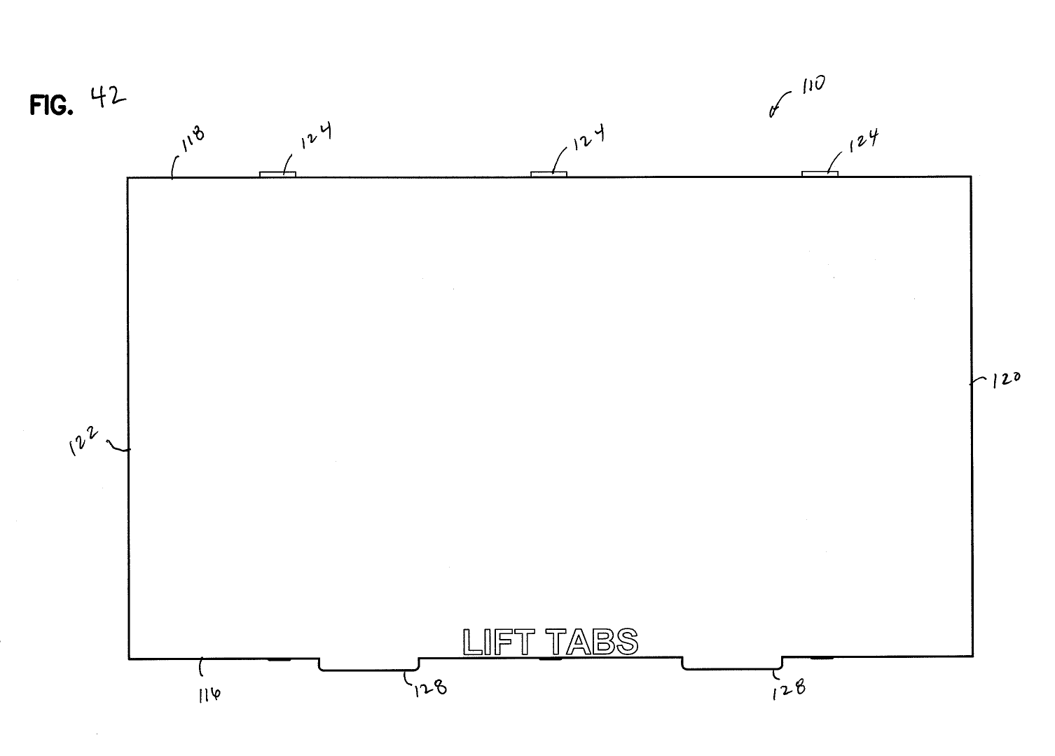

In reference now to FIGS. 12-14 and 39-41, in these example embodiments, the lids 52 in each of the rows 32-35 are connected together by a common flange 58. The flange 58 can be snapped into a receiving groove 60, 62 (FIGS. 8, 11, 33, 35-37, and 49). FIGS. 5, 31, 32, and 38 show an example of the flange 58 snapped into one of the receiving grooves 60, 62 of the base 22. As can be seen from a review of these figures, each receiving groove 60, 62 is sized to receive two flanges 58, when the lids 52 are arranged in the manner shown, with the rear row walls 50 next to each other.

Each of the lids 52 can be selectively snapped into a closed engagement with the based 22. Many different implementations are possible. In each of the embodiments of container 20, 220, and 320, the free end 56 has a locking arm 64 extending from a remaining portion of the lid 52 and toward a direction of the compartment interior volume 30. The locking arm 64 includes a lid catch 66, which engages in a snap fit with a base catch 68 on the base 22. For the container 20 and 320, the locking arm 64 extends from an inside surface of the lids 52, and the base catch 68 extends from an outside surface 70 (FIG. 5) of the front row wall 48. In the embodiment of container 220 and as can be seen in FIG. 38, the base catch 68 includes a recess 72 that is defined by an inside surface 74 of the front row wall 48.

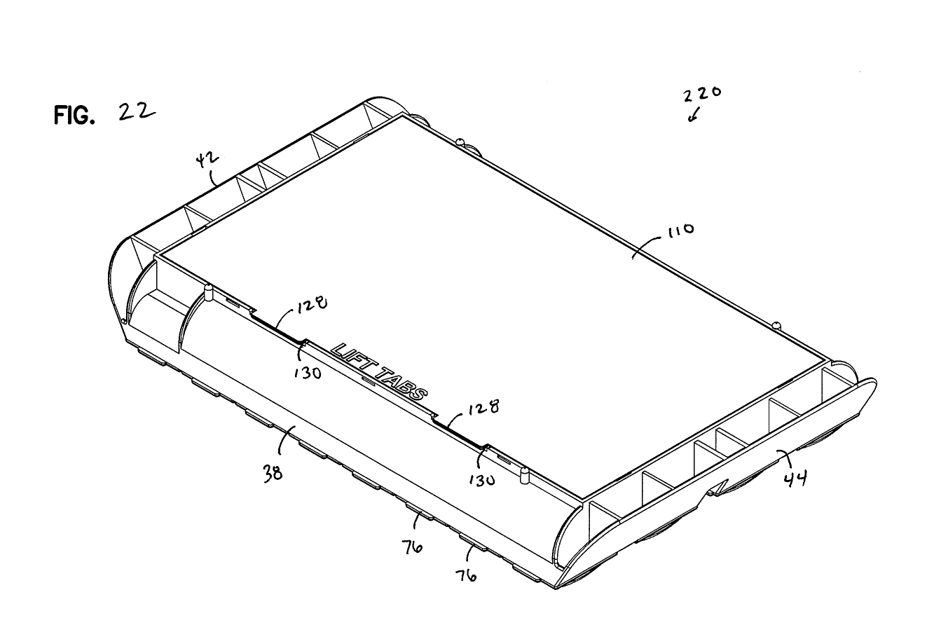

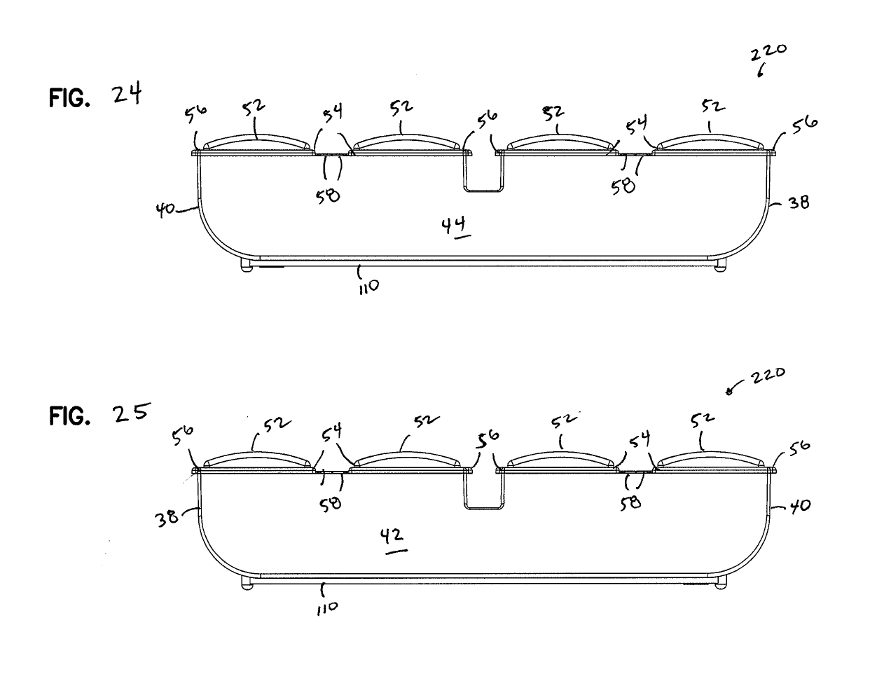

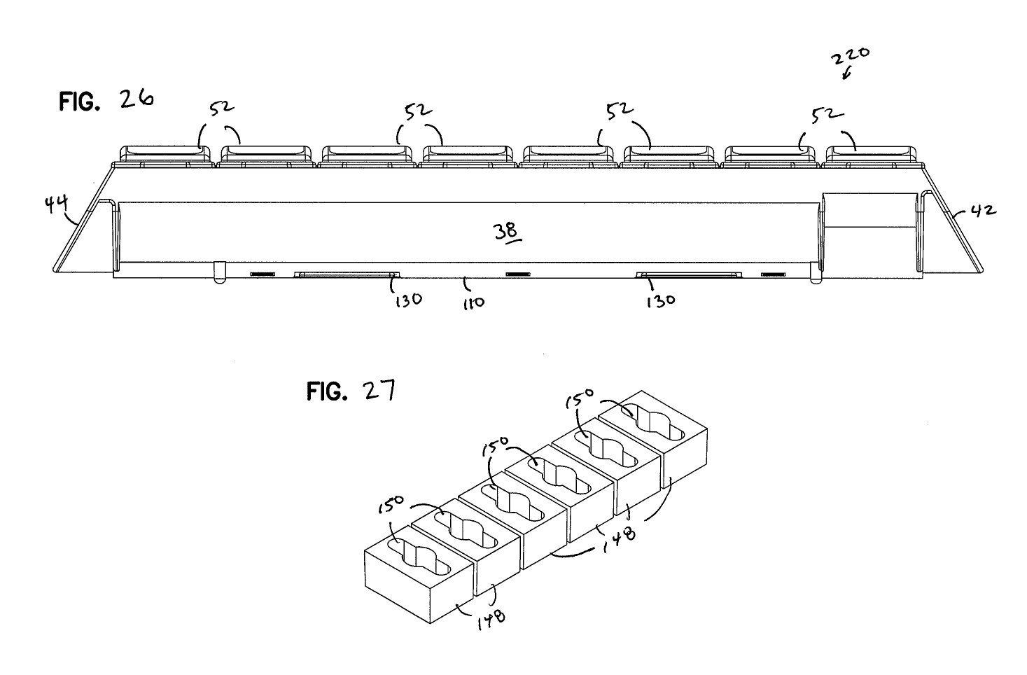

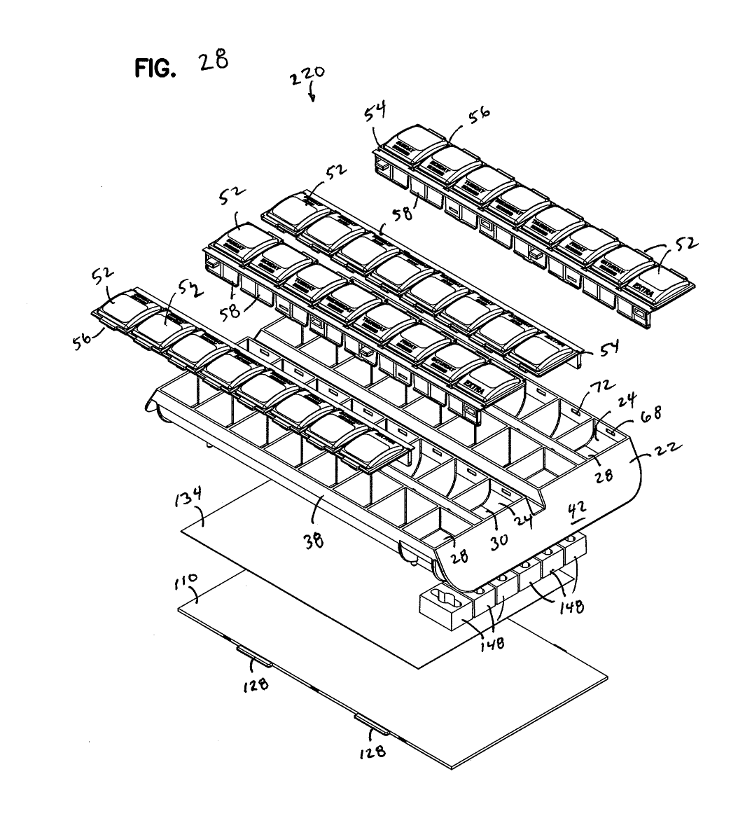

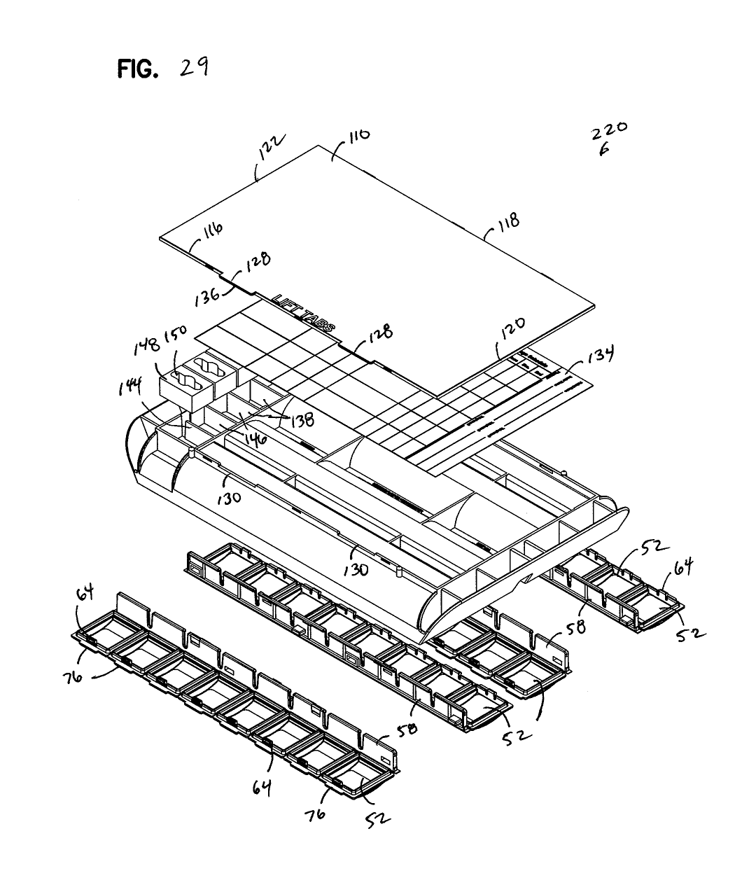

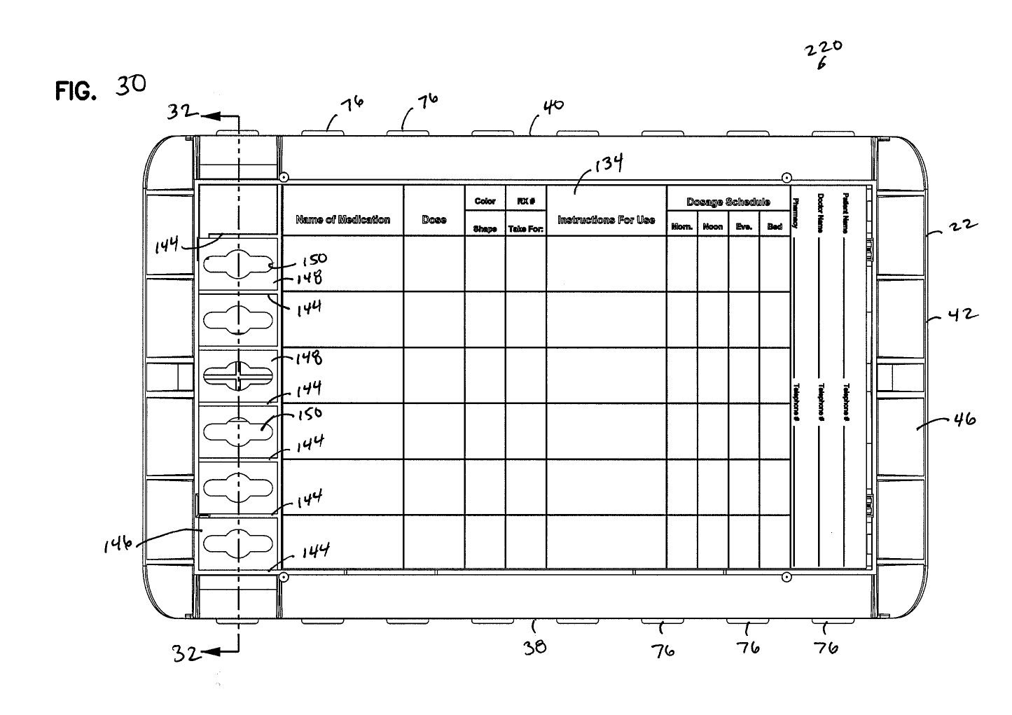

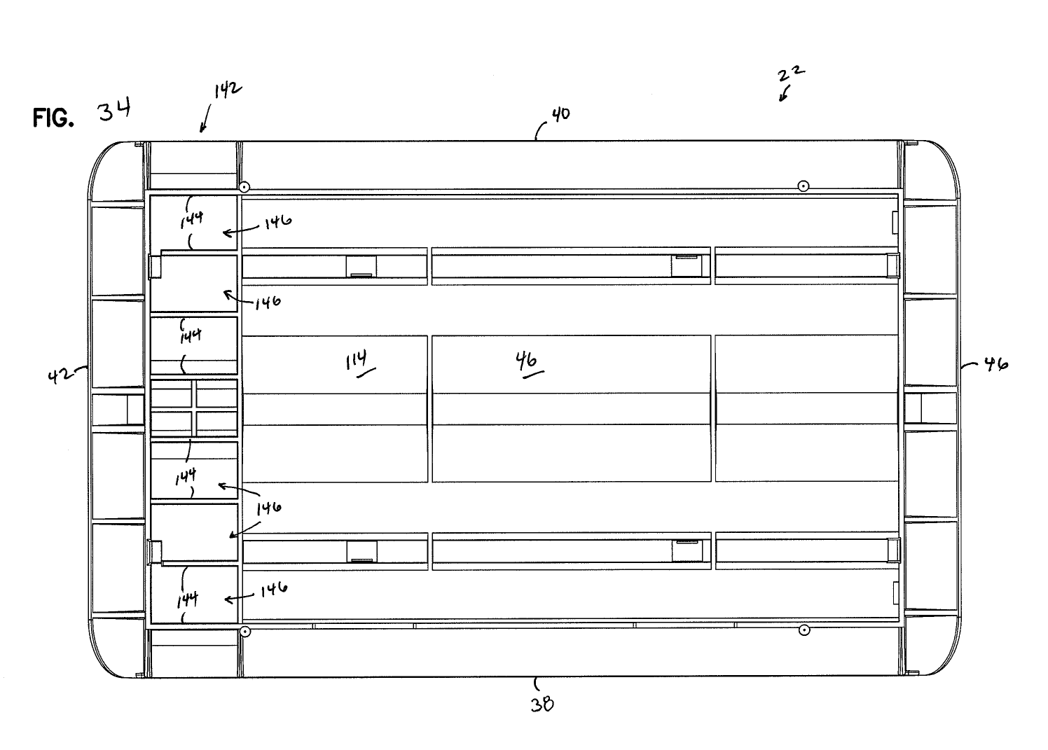

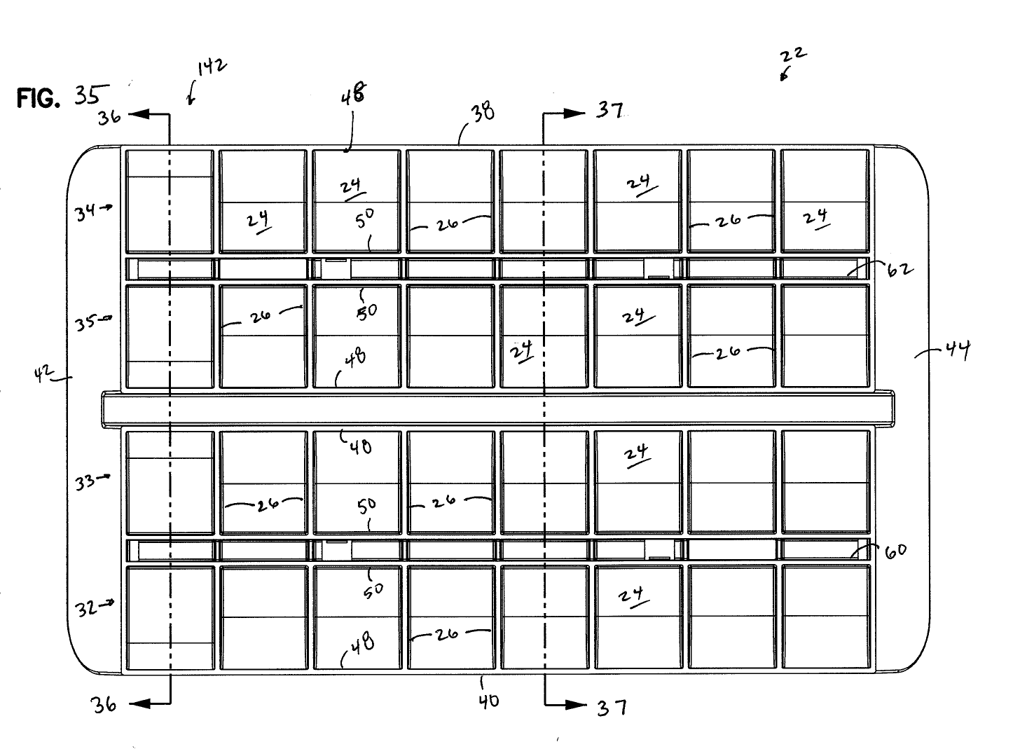

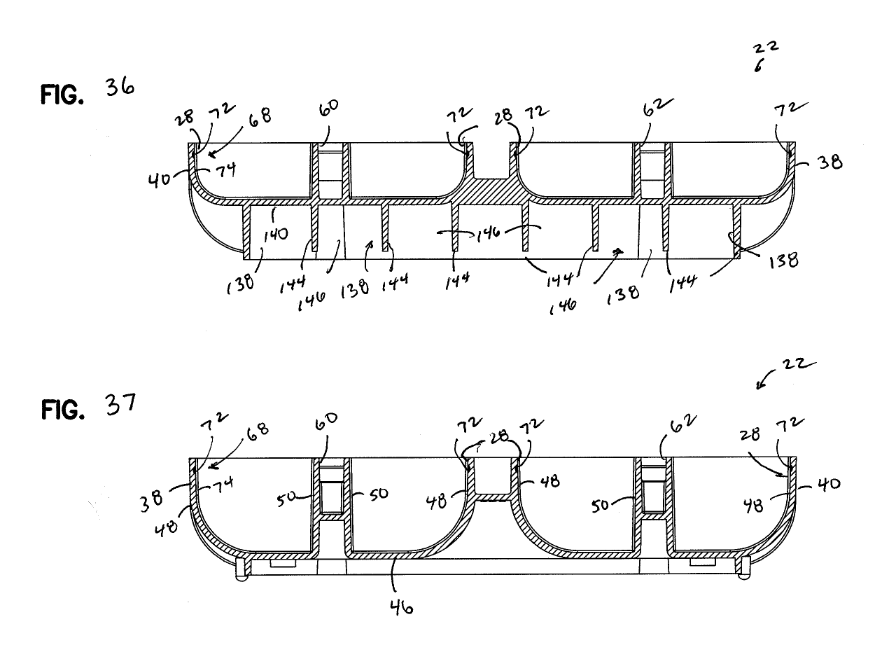

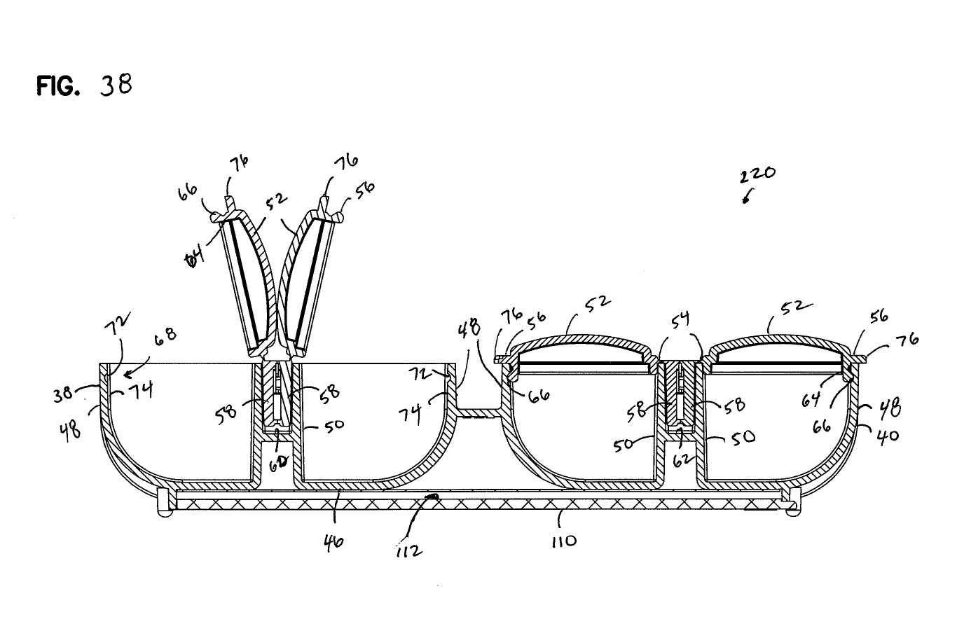

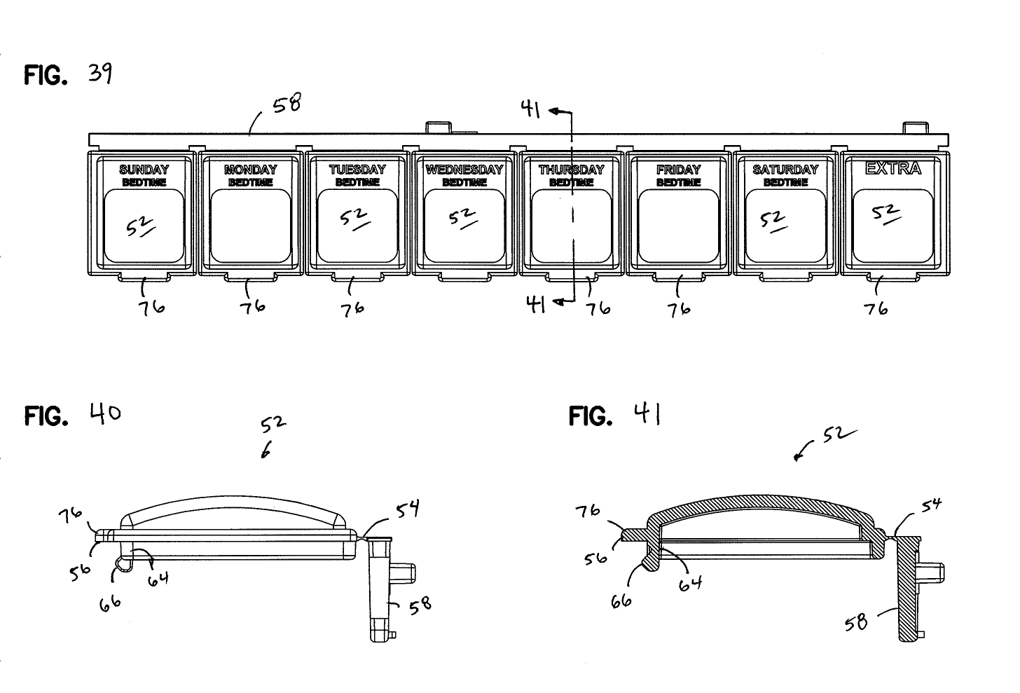

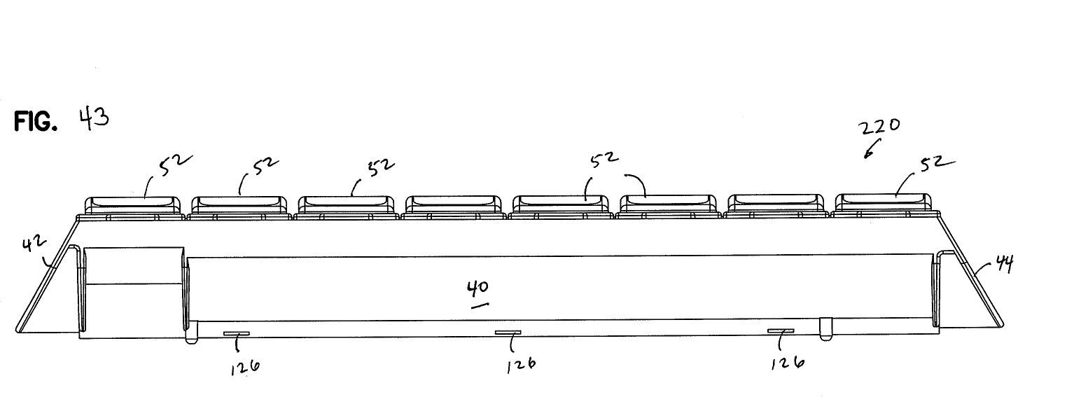

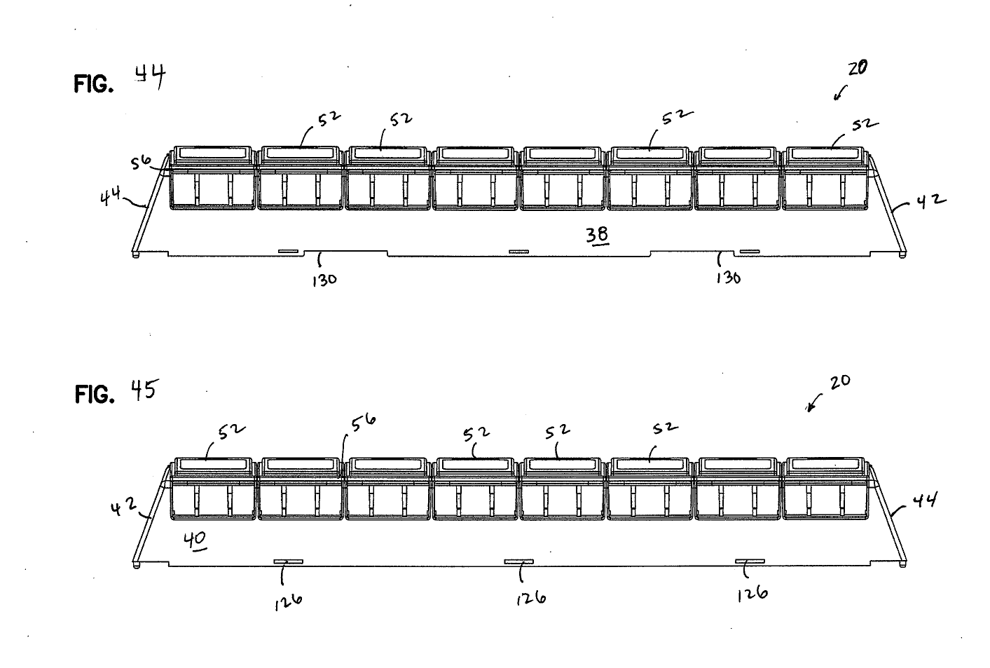

In the container 220 of FIGS. 21-42, there is also a lift tab 76 projecting from the free end 56 of each of the lids 52. In this manner, to open the lids 52 in the container 220, a person applies a force to the underside of the lift tab 76 to release the lid catch 66 from engagement with the base catch 68.

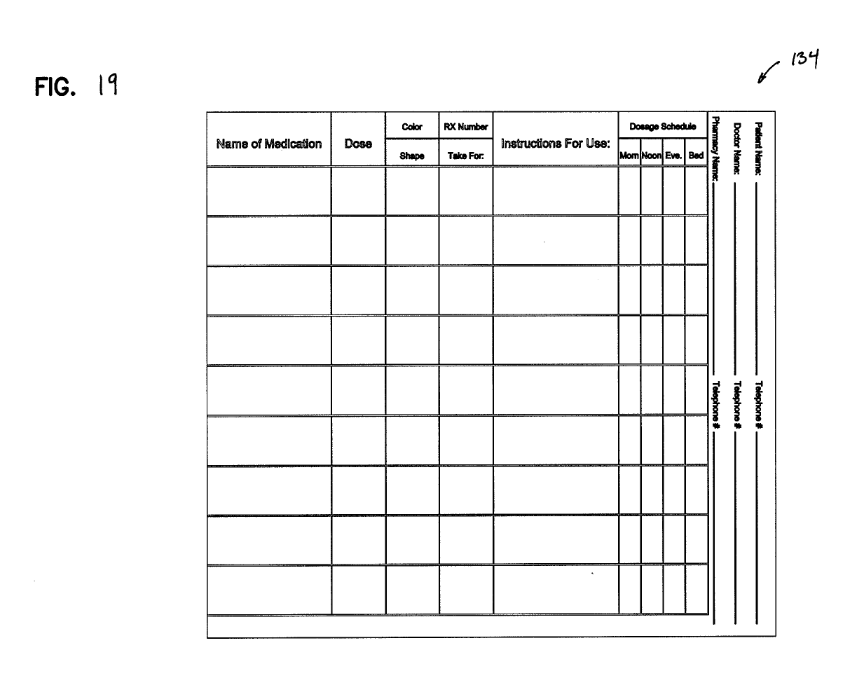

Referring now to the embodiment for container 20 and 320, which have the same lids 52, and in particular to FIGS. 12-18, the free end 56 of each lid 52 can also include first and second standoffs 78, 79 (FIG. 12). The locking arm 64 is centered between the first and second standoffs 78, 79. The standoffs 78, 79 are configured to extend downwardly from the lid 52 and rest on a respective tab 80. The tabs 80 are described further below.

For container 20 and 320, each of the lids 52 includes a lip member 82 (FIG. 5). The lip member 82 engages inside surface 74 of the front row wall 48 of the base 22. In this example, the engagement of the lip member 82 and the inside surface 74 of the front row wall 48 against each other substantially seals the free end 56 of the lid 52 with the front row wall 48 of the base 22.

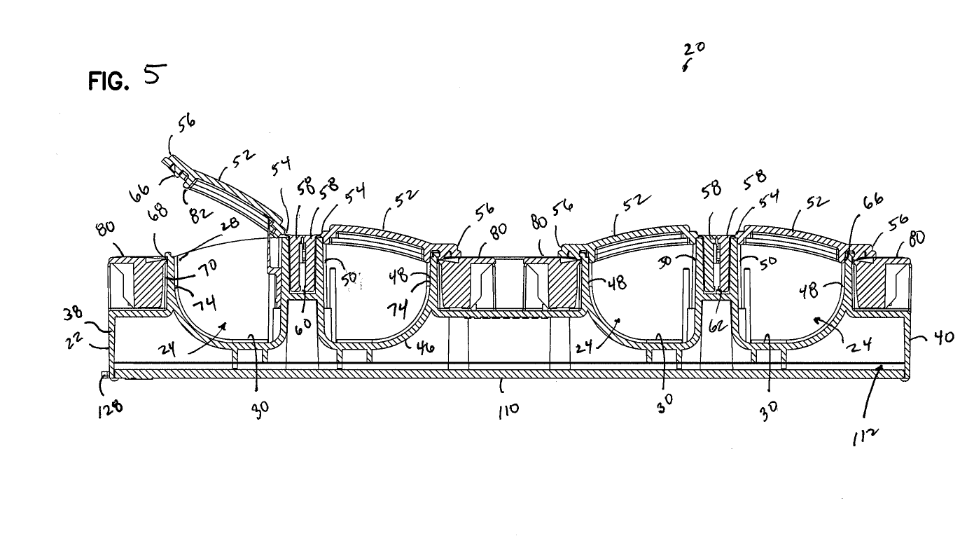

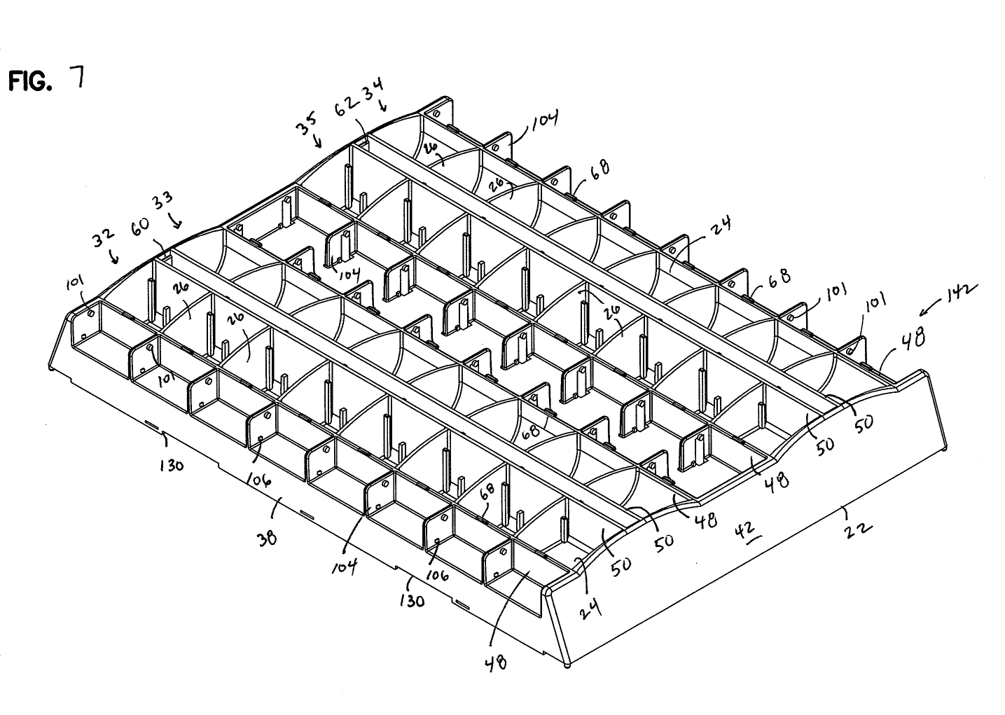

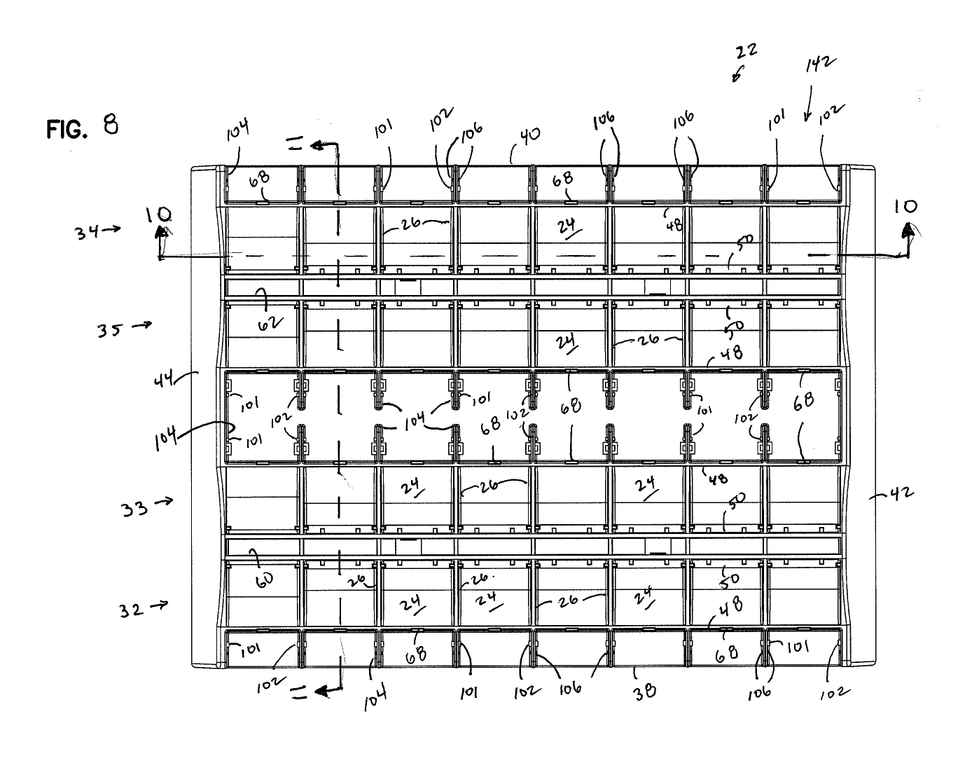

As mentioned above, for the container 20 and 320, there is at least one tab 80. In the embodiment depicted with respect to container 20, there are a plurality of tabs 80. In the examples shown in FIGS. 1-20 and 46, there is one tab 80 for each compartment 24. In other embodiments, there can be different types of arrangements for opening and closing the compartments 24, so each compartment 24 would not necessarily need a tab 80. In the example shown in the embodiment of FIGS. 1-20 and 46, each of the tabs 80 is pivotally connected to the base 22 at a location opposite the front row wall 48 from the interior volume 30. Each tab 80 is constructed and arranged such that depressing the tab 80 causes a respective lid 52 to disengage from the snap connection with the front row wall 48 of the base 22 and thereby position the lid 52 to uncover the access opening 28.

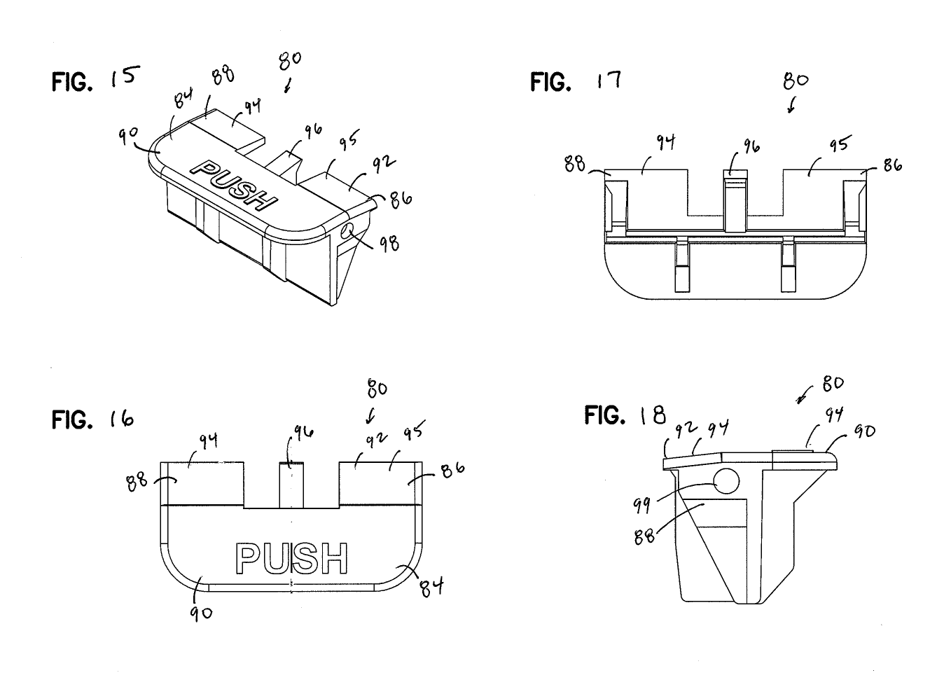

FIGS. 15-18 illustrate the tab 80 in greater detail. In the depicted embodiment, the tab 80 includes a top surface 84, a first end portion 86, and a second end portion 88. The top surface 84 includes a front portion 90 and a back portion 92. The back portion 92 is configured to pivot upwards when the front portion 90 is moved downwards. The back portion 92 is configured to raise the free end 56 of the lid 52 and release the locking arm 64 from the base catch 68 when the front portion 90 is depressed.

In the example embodiment depicted, and still in reference to FIGS. 15-18, the back portion 92 includes first and second side back members 94, 95 separated by a center back member 96. The center back member 96 is configured to contact the locking arm 64 and move the locking arm 64 from the engaged position (in which the lid catch 66 is engaged with the base catch 68) to a disengaged position (in which the lid catch 66 and base catch 68 are non-engaged). The first side back member 94 and second side back member 95 are configured to contact the first and second standoffs 78, 79 and move them upwards when the front portion 90 of the tab 80 is depressed. This engagement between the side back members 94, 95 and the standoffs 78, 79 further assist with disengaging the lid catch 66 from the base catch 68.

In reference now to FIGS. 15 and 18, in the depicted embodiment, the first end portion 86 and the second end portion 88 each includes a recess 98, 99. Each recess 98, 99 is configured to engage a pivot protrusion 101, 102 (FIGS. 7 and 8) on a front end portion 104 of each of the rows 32-35 (FIGS. 7 and 8). The front end portion 104 is generally perpendicular to the front row wall 48. The front end portion 104 is on a side of the front row wall 48 that is opposite from interior volume 30.

The front end portion 104 includes, along the base front wall 38 and base rear wall 40 protrusions 106 (FIGS. 7 and 8) extending therefrom. The protrusions 106 act as rotational stops to limit the rotation of the tab 80 when the lid 52 is locked in place with the base 22. When the lid 52 is disengaged from the base 22, engagement between the center back member 96 and the base catch 68 prevent over-rotation.

One example of a push tab assembly, which can be utilized in the embodiment of FIGS. 1-20 and 46-52, is described in U.S. Pat. No. 7,624,890, incorporated by reference herein in its entirety.

In accordance with principles of this disclosure, the multiple compartment container 20, 220, and 320, includes a cover 110. The cover 110 is movably attached to the base 22 and is adjacent to and spaced from the bottom wall 46 to define a register holder 112 therebetween. The cover 110 is constructed and arranged to move relative to the base 22 and from the base bottom wall 46 to provide access to the register holder 112.

In the example shown for container 20 and 220, the cover 110 is pivotable toward and away from the exterior side 114 of the base bottom wall 46. For container 320, the cover 110 is slideably attached to the base 22 and is constructed and arranged to slideably move relative to the base 22 and along the base bottom wall 46 to provide access to the register holder 112.

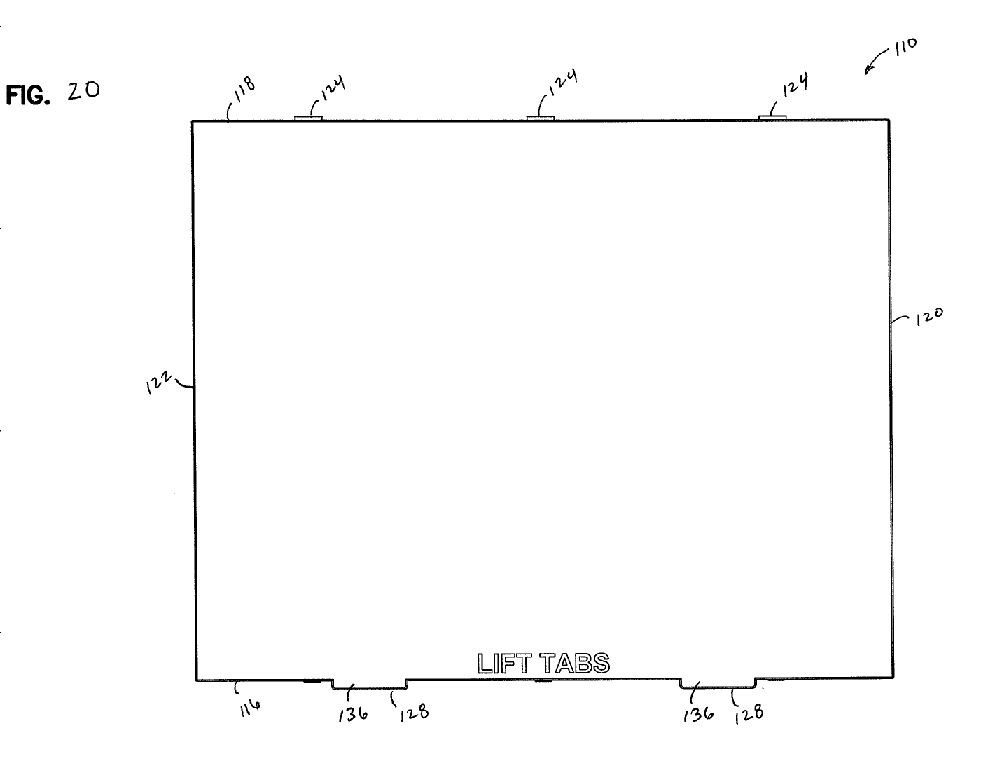

Many different implementations are possible. In the examples shown, and in reference to FIGS. 20, 42, and 48, the cover 110 includes front and rear edges 116, 118, with first and second side edges 120, 122 extending therebetween. For the containers 20, 220, projecting from the rear edge 112 is a plurality of pivot tabs 124 projecting therefrom.

For containers 20, 220, the pivot tabs 124 are received by slots 126 located within the base rear wall 40 of the base 20. The slots 126 can be seen in FIGS. 43 and 45.

For containers 20, 220, along the front edge 116 of the cover 110 is at least one lift tab 128. In the example embodiment shown, there is a plurality of lift tabs 128, illustrated as being two lift tabs 128. The lift tabs 128 are received within recesses 130 and releasably attach therein with a snap engagement. In this manner, the cover 110 can be releasably attached to the base 22 by orienting the pivot tabs 124 within the slots 126, and then pivoting or rotating the cover 110 to be against the base 22, in which the lift tabs 126 releasably snap into engagement with structure on the base 22 within the recesses 130.

For containers 20, 220, it should be appreciated that the lift tabs 128 provides the user with handles 136 to grasp with their fingers in order to move the cover 110 and pivot it relative to the base 22. The lift tabs 128 project away from the base 22, such that a person's fingers can fit behind the lift tabs 128.

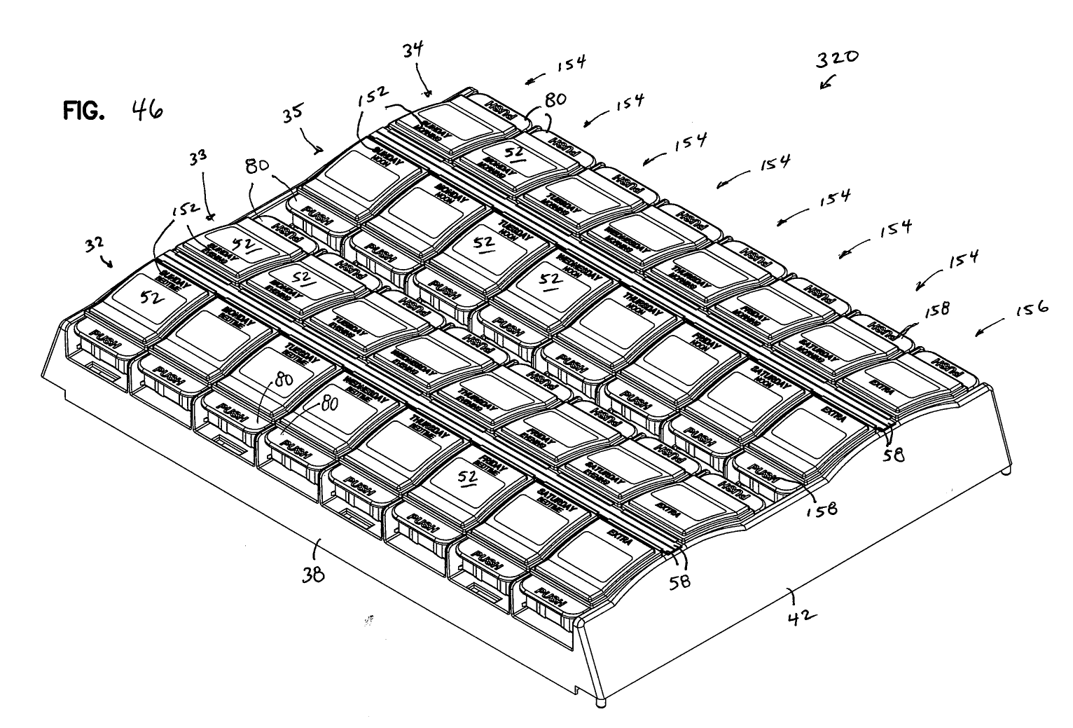

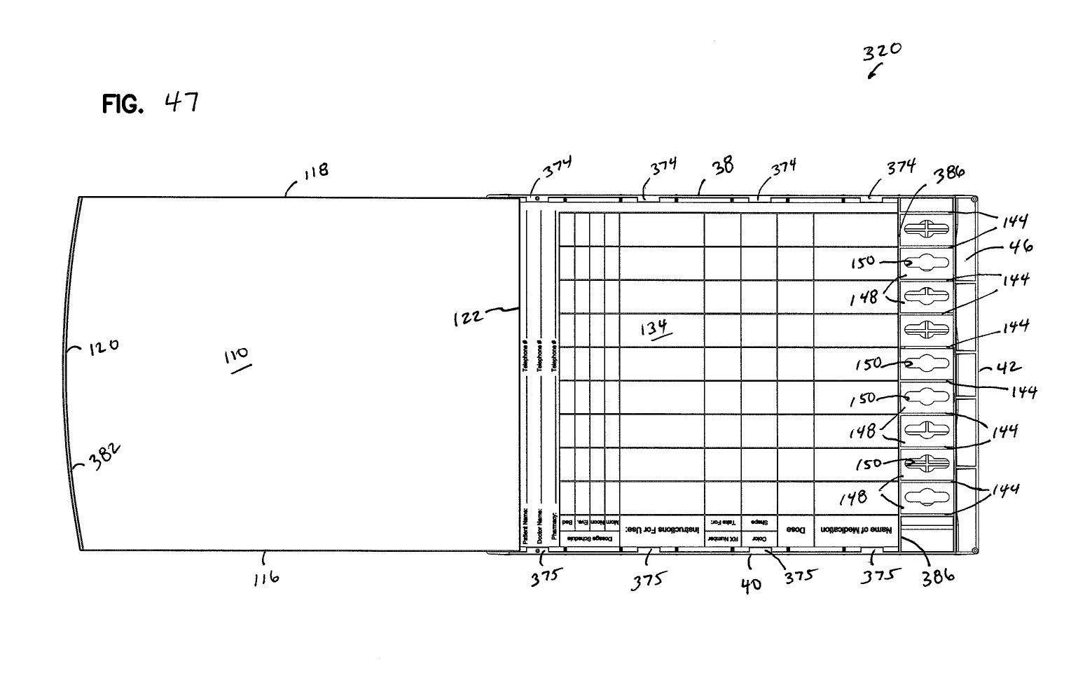

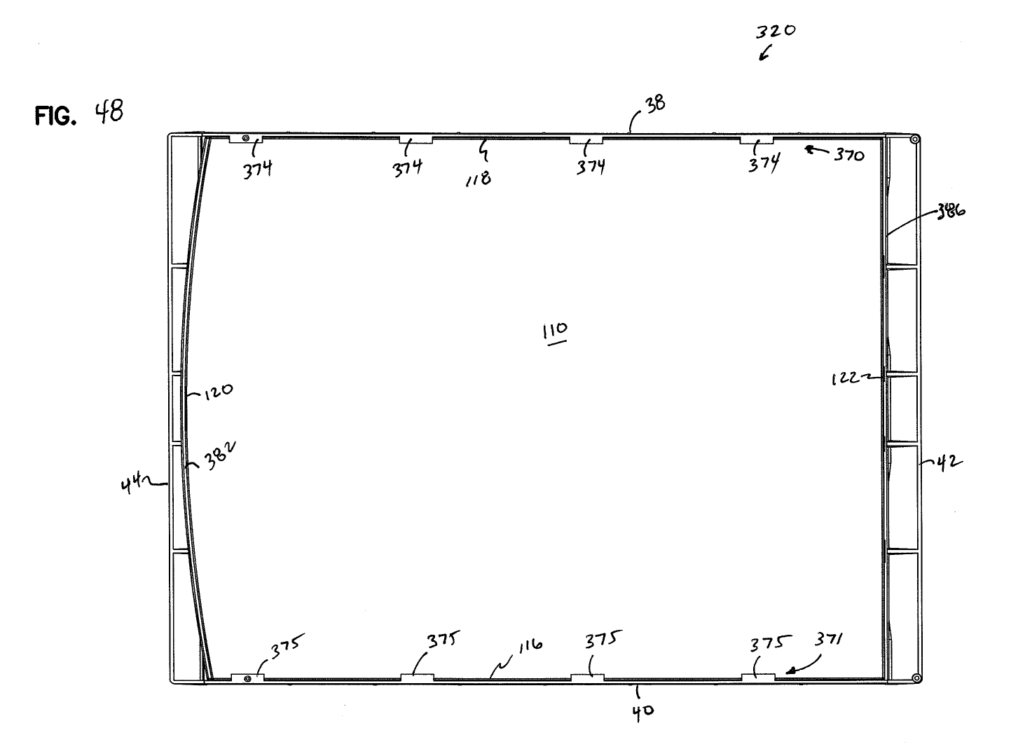

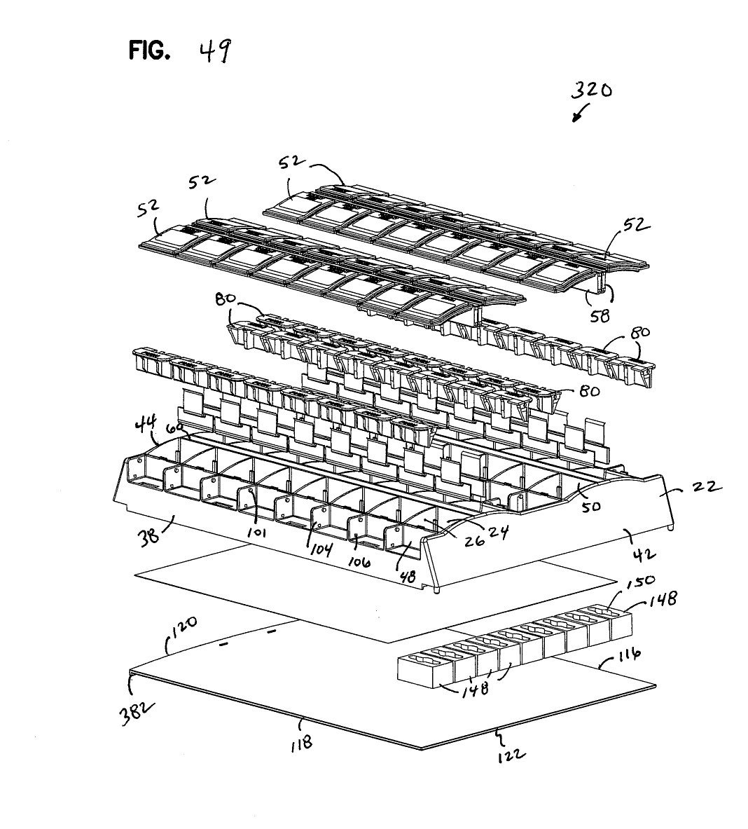

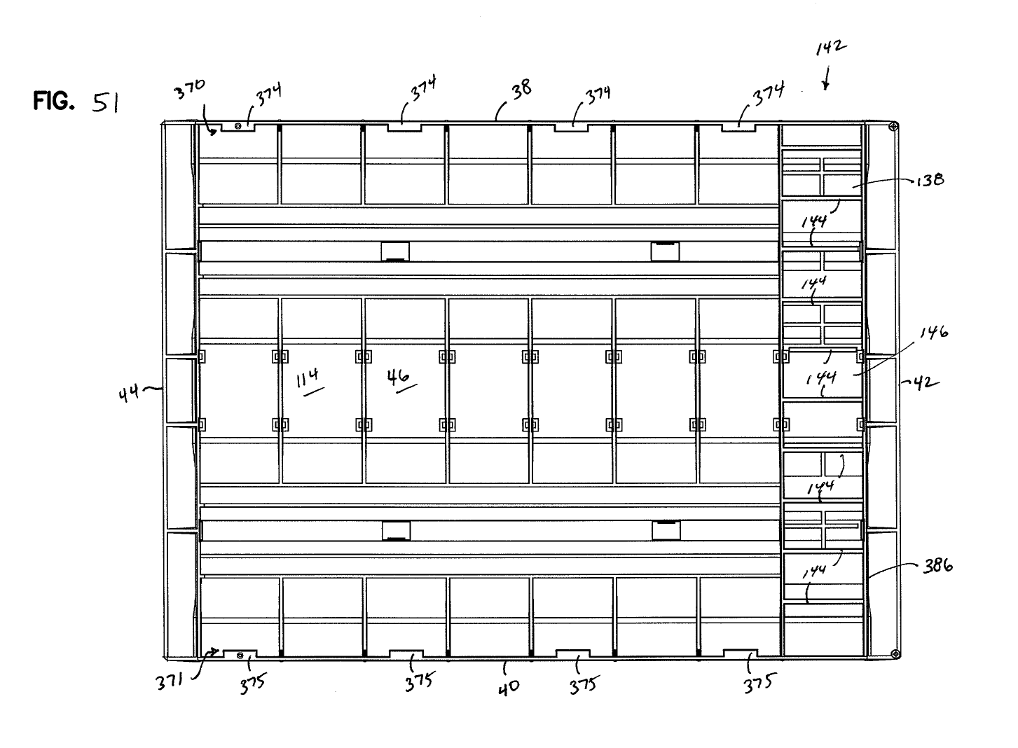

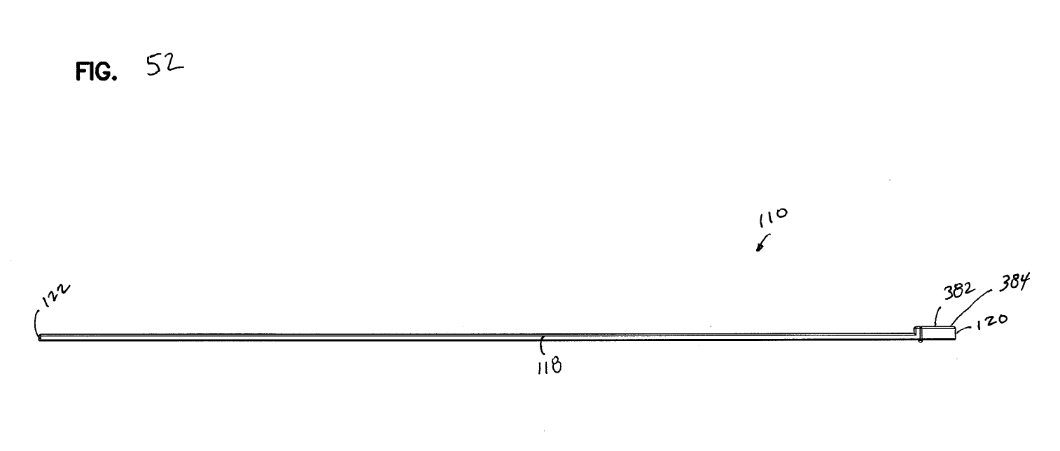

For the container 320 of FIGS. 46-52, the base 22 defines first and second slide rails 370, 371 (FIGS. 50 and 51) along the front end portion 104 of the base 22 and along the rear wall 40 of the base 22. The slide rails 370, 371 can be continuous along the front end portion 104 and base rear wall 40, but in the embodiment shown, the rails 370, 371 are in the form of discontinuous discrete sections 374, making up the first slide rail 370, and 375, making up the second slide rail 371. In the embodiment shown, there are four sections 374 and four sections 375. Each section includes a lip 378, 379 which holds the cover 110 in place. As can be appreciated by comparing FIGS. 47 and 48, the cover 110 is slideable within the slide rails 370, 371 relative to the base 22 to allow access to the register holder 112.

Still in reference to container 320, the cover 110 includes a handle 382. In reference to FIG. 52, the handle 382 includes a projection 384 along the first side edge 120. The projection 384 extends away from a remaining portion of the cover 110. When the cover 110 is operably slid into a full covering position within the slide rails 370, 371 in the base 22, the handle 382 will be projecting or extending away from a direction of the rest of the container 320. In this manner, the user can move the cover 110 by placing one's fingers adjacent to the handle 382 and applying a pushing or pulling force against the handle 382, which will slide the cover 110 within the slide rails 370, 371 and move the cover 110 relative to the base 22 and along the bottom wall 46 to provide access to the register holder 112. After accessing the register holder 112, the cover 110 can then be slid within the slide rail 370, 371 back into a covering position as shown in FIG. 48. It should be appreciated that the cover 110 in the embodiment of FIGS. 46-52 is constructed and arranged to slide in a direction toward and against the first and second side walls 42, 44 of the base 22.

The cover 110 is movably attached to the base 22 to allow access to the register holder 112. The register holder 112 is for containing and holding a removable card 134. In preferred embodiments, the cover 110 is made from a transparent material, such that any information on the card 134 is visible through the cover 110.

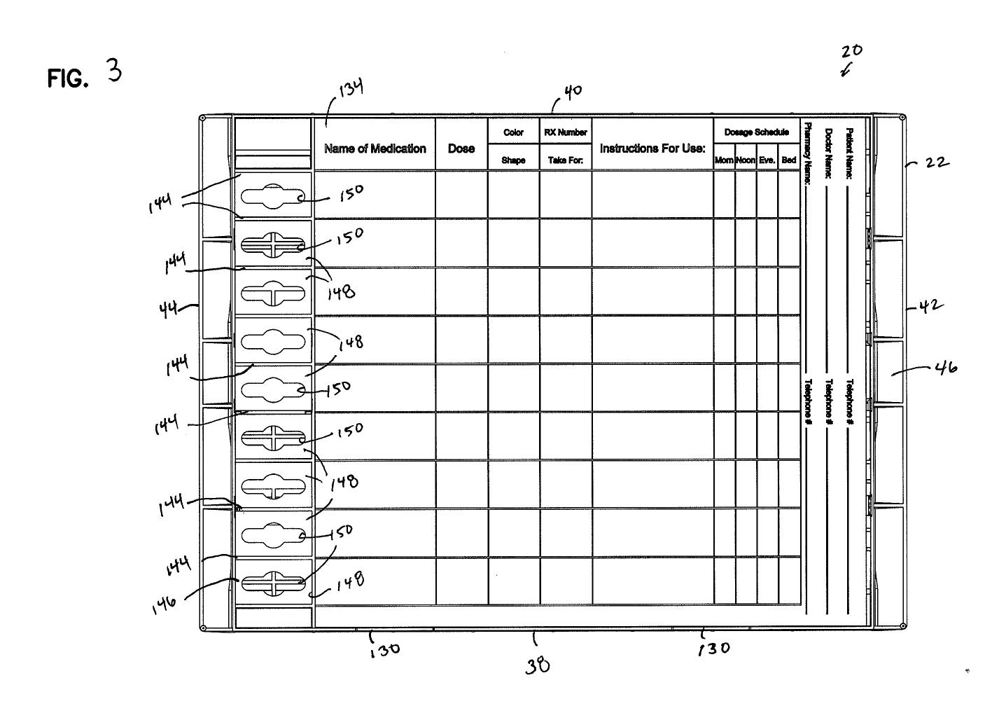

FIGS. 3, 30, and 47, show one example card 134. The card 134 can be made from paper or cardboard, and it can contain any type of information. In the example show, the card 134 includes medical information with fields for the name of the medication, the dosage, the color and shape, the medical condition to take the medication, the prescription number, instructions for use, dosage schedule, and information on the patient name and phone number, doctor name and phone number, and pharmacy name and phone number. Information can be written on the card 134 and then placed in the register holder 112 when the cover 110 is either removed from the base 22 or pivoted away from the base 22 or slid from the base (FIGS. 46-52). For containers 20, 220, after the card 134 is in the register holder 112, the cover 110 can be snapped into attached engagement with the base 22. This can be done by placing the pivot tabs 124 within the slots 126, and then pivoting or rotating the cover 110 until the cover 110 is against the base 22 and the lift tabs 128 are within the recesses 130. The lift tabs 128 can then be snapped into snap engagement with the base 22 in the region of the recesses 130. For container 320, after the card 134 is in the register holder, the cover 110 can be slid into covering position with the base 22 by sliding the front edge 116 within the second slide rail 371 and the rear edge 118 within the slide rail 370 until the second side edge 122 of the cover 110 is adjacent to or against the inner wall 386 of the base 22. As can be seen in FIG. 50, the wall 386 extends between the base front wall 38 and base rear wall 40 and is generally parallel and adjacent to the base first side wall 42.

In this manner, the container 20, 220, 320, can include medication in the compartments 24, and the user can then view the information on the registration card 134 by merely turning the container 20, 220, 320, over and viewing the information on the card 134 through the transparent cover 110.

If there was a change in medication or dosage or anything else, the card 134 can be accessed by pivoting (container 20, 220) or sliding (container 320) the cover 110 relative to the base 22 to provide access to the card 134. The information can be changed on the card 134, or a new card 134 can be provided within the register holder 112. Then, the cover 110 can then again be pivoted (container 20, 220) or slid (container 320) against the base 22 and snapped into engagement.

In accordance with principles of this disclosure, the base bottom wall 46 is recessed along at least one of the compartments 24 in the base 22 to provide a second interior volume 138 between the recessed bottom wall 140 and the cover 110. The second interior volume 138 is accessible by moving the cover 110 away from the base 22 to expose the second interior volume 138.

In this example embodiment, the recessed bottom wall 140 extends along one column 142 of compartments 24. By “one column,” it is meant that the recessed bottom wall 140 extends along one compartment 24 in each of the rows 32-35 that are aligned with each other. In the example shown, the column of compartments 142 are adjacent to the first side wall of the base 42, but of course, could be anywhere along the base 22. This results in the interior volumes 30 of each of the compartments 24 in the column of compartments 142 as being more shallow than the other interior volumes 30. On an opposite side of the recessed bottom wall 140, the second interior volume 138 results.

The second interior volume 138 can be used for a variety of functions. In the example shown, the second interior volume 138 includes a plurality of partitions 144, dividing the second interior volume 138 into a plurality of bottom storage volumes 146.

The bottom storage volumes 146 can be used for a variety of functions. In the example shown, each of the bottom storage volumes 146 can include a flexible pill holder 148 therein. The pill holder 148 can be used to hold a pill therein against gravity.

An example pill holder 148 is shown in FIGS. 3, 6, 27, 30, 32, and 49. The pill holder 148 can be made from a flexible material, such as an open cell foam material and include an opening 150 therewithin. The pill holder 148 is flexible enough such that a pill can be placed within the opening 150, and the flexibility of the material of the pill holder 148 will accommodate the pill within the opening 150 and hold it in place against gravity. In the example shown, there is one pill holder 148 placed within each of the bottom storage volumes 146 of the second interior volume 138. In other embodiments, the bottom storage volumes 146 do not necessarily need to each hold a pill holder 148.

It should be appreciated that extra pills can be held within the openings 150 of the pill holders 148 within the bottom storage volumes 146. These extra pills would be accessible by moving the cover 110 relative to the base 22 to expose access to the second interior volume 138.

From a review of FIGS. 2, 23, and 46, it can be seen how the container 20, 220, 320 includes written indicia 152 on each of the lids 52. The indicia 152 can say anything for purposes of the container 20, 220, 320. In the example depicted, the indicia 152 include an identification of the day of the week thereon, and a general indication of the time of day. For example, the containers 20, 220, 320 can be organized to have at least seven columns 154, in which each column 154 represents one day of the week. The example embodiments show eight columns 154, representing each day of the week and an extra column 156 for storing extra pills.

In the example shown, each column 154 has on the indicia 152 the day of the week and the general time of the day. For example, one column includes the words “Sunday morning” on one lid 52 in the third row 34, the words “Sunday noon” on the lid 52 in the fourth row 35, the words “Sunday evening” on the lid 52 in the second row 33, and the words “Sunday bedtime” on the lid 52 in the first row 32. The indicia 152 in the extra column 156 says the word “extra.”

On each of the lids 52 there may also be braille to assist the visually impaired. Of course, many variations in the indicia 152 are possible.

For the container 20, 320 in FIGS. 1 and 46, each of the tabs 80 includes the word “push” at 158 to provide instructions on how to operate the container 20 in order to provide access to the interior volume 30. The instruction at 158 provides the user with information that to move the lid 52 from the locked and closed position to the open position uncovering the access opening 28, the tab 80 should be pushed. Of course, other variations on the instruction 158 are possible.

A method of using a multiple compartment container can be implemented utilizing the principles as disclosed herein. First, a container, such as container 20, 220, 320 is provided. The container 20, 220, 320 will include cover 110 movably attached to the base 22 and adjacent to and spaced from the bottom wall 46 to define the register holder 112 therebetween. The method includes moving the cover 110 relative to the base 22 to provide access to the register holder 112.

The method can include placing the removable card 134 with information in the register holder 112.

The step of moving the cover 110 includes unsnapping the cover 110 from the base 22 and pivoting the cover 110 relative to the base 22 for containers 20, 220. For container 320, the step of moving the cover 110 includes sliding the cover 110 to move relative to the base 22 and along the bottom wall 46 to provide access to the register holder 112.

The method can include depressing front portion 90 of one of the tabs 80 to cause a rear portion 92 of the tab 80 to contact a respective lid 52 and disengage the free end 56 from the respective front row wall 48 and thereby position the respective lid 52 to uncover the respective access opening 28.

The step of providing container 20, 220, 320 includes providing the container 20, 220, 320 including first, second, third, and fourth rows 32-35 in which there are eight compartments 24 in each of the rows 32-35. The rear row wall 50 of each of the first and second rows 32, 33 are adjacent to each other, and the rear row wall 50 of each of the third and fourth rows 34, 35 are adjacent to each other. The front row wall 48 of each of the second and fourth rows 33, 35 are adjacent to each other.

The above includes example principles of this disclosure. Many embodiments can be made applying these principles.

What is claimed is:

1. A multiple compartment container comprising:
(a) a base having at least first and second rows of compartments, each compartment having an access opening providing access to an interior volume;
(i) the base having a base front wall, a base rear wall opposite of the base front wall, a first side wall extending between the base front wall and base rear wall, a second side wall extending between the base front wall and rear wall, and a base bottom wall opposite of the access opening;
(ii) each compartment row having a front row wall and a rear row wall;
(b) a plurality of lids;
(i) each lid having an attached end being movably attached to the rear row wall, and a free end movable to and away from the front row wall such that the lid selectively covers and uncovers the access opening of a respective compartment; and
(c) a cover movably attached to the base and being adjacent to and spaced from the bottom wall to define a register holder therebetween.

2. A container according to claim 1 wherein:
(a) the cover is tranparent.

3. A container according to claim 2 further comprising:
(a) a removable card with information oriented in the register unit volume.

4. A container according to claim 1 wherein:
(a) the rear row wall of each of the at least first and second rows are adjacent to each other.

5. A container according to claim 1 wherein:
(a) the at least first and second rows of compartments include first, second, third, and fourth rows of compartments.

6. A container according to claim 5 wherein:
(a) each of the four rows of compartments includes at least 7 compartments in each row.

7. A container according to claim 5 wherein:
(a) the rear row wall of each of the first and second rows are adjacent to each other;
(b) the rear row wall of each of the third and fourth rows are adjacent to each other; and
(c) the front row wall of each of the second and third rows are adjacent to each other.

8. A container according to claim 7 wherein:
(a) each lid includes a lid catch at the free end releasably engaging a base catch on the front row wall.

9. A container according to claim 8 further comprising:
(a) a plurality of tabs pivotably connected to the base at a location opposite the front row wall from the interior volume, wherein each tab is constructed and arranged such that depressing a front portion of the tab causes a rear portion of the tab to contact a respective lid and disengage the free end of the lid from the front row wall and thereby position the lid to uncover the access opening.

10. A container according to claim 1 wherein:
(a) each lid includes a lid catch at the free end releasably engaging a base catch on the front row wall.

11. A container according to claim 10 further comprising:
(a) a plurality of tabs pivotably connected to the base at a location opposite the front row wall from the interior volume, wherein each tab is constructed and arranged such that depressing a front portion of the tab causes a rear portion of the tab to contact a respective lid and disengage the free end of the lid from the front row wall and thereby position the lid to uncover the access opening.

12. A container according to claim 1 wherein:
(a) the bottom wall is recessed along at least a portion of the base to provide a second interior volume between the recessed bottom wall and the cover; the second interior volume being accessible by moving the cover to expose the second interior volume.

13. A container according to claim 12 wherein:
(a) the second interior volume includes a flexible pill holder to hold a pill therein against gravity.

14. A container according to claim 12 wherein:
(a) the at least first and second rows of compartments include first, second, third, and fourth rows of compartments; and
(b) there are at 8 compartments in each of the first, second, third, and fourth row to result in: 4 rows having 8 compartments, and 8 columns having 4 compartments.

15. A container according to claim 14 wherein:
(a) the recessed portion of the bottom wall is along one of the columns.

16. A container according to claim 1 wherein:
(a) the cover is slidably attached to the base and is constructed and arranged to slidably move relative to the base and along the bottom wall to provide access to the register holder.

17. A container according to claim 16 wherein:
(a) the cover is constructed and arranged to slide in a direction toward and against the first and second side walls.

18. A method of using a multiple compartment container, the method comprising:
(a) providing a container including a base having at least first and second rows of compartments, each compartment having an access opening providing access to an interior volume;
(i) the base having a base front wall, a base rear wall opposite of the base front wall, a first side wall extending between the base front wall and base rear wall, a second side wall extending between the base front wall and rear wall, and a base bottom wall opposite of the access opening; each compartment row having a front row wall and a rear row wall;
(ii) a plurality of lids; each lid having an attached end being movably attached to the rear row wall, and a free end movable to and away from the front row wall such that the lid selectively covers and uncovers the access opening of a respective compartment;
(iii) a cover movably attached to the base and being adjacent to and spaced from the bottom wall to define a register holder therebetween; and
(b) moving the cover relative to the base to provide access to the register holder.

19. A method according to claim 18 further comprising:
(a) placing a removable card with information in the register holder.

20. A method according to claim 18 wherein:
(a) the step of moving the cover includes one of (i) disengaging the cover from the base and pivoting the cover relative to the base; or (ii) sliding the cover to move relative to the base and along the bottom wall to provide access to the register holder.
